(19) United States
(12) Patent Application Publication
(10) Pub. No.: US 2021/0254812 A1
(43) Pub. Date: Aug. 19, 2021

(54) POLYMER HOUSING FOR A RECESSED LIGHTING SYSTEM AND METHODS FOR USING SAME

(71) Applicants: Michael D. Danesh, Carson, CA (US); Amir Lotfi, Redondo Beach, CA (US); Ali A. Nikooyan, Santa Ana, CA (US)

(72) Inventors: Michael D. Danesh, Carson, CA (US); Amir Lotfi, Redondo Beach, CA (US); Ali A. Nikooyan, Santa Ana, CA (US)

(21) Appl. No.: 17/118,742

(22) Filed: Dec. 11, 2020

Related U.S. Application Data
(63) Continuation of application No. PCT/US2019/036477, filed on Jun. 11, 2019.
(60) Provisional application No. 62/791,398, filed on Jan. 11, 2019.
(60) Provisional application No. 62/749,462, filed on Oct. 23, 2018.
(60) Provisional application No. 62/683,562, filed on Jun. 11, 2018.

(51) Int. Cl. F21V 15/01; F21V 23/00; F21V 21/04

(52) U.S. Cl. CPC F21V 15/01; F21V 21/048; F21V 23/001

(57) ABSTRACT

A recessed lighting system includes multiple components formed from a polymer to reduce the number of components in the system, lower the cost of manufacture, and simplify the installation of the recessed lighting system. In one example, a recessed lighting system includes a housing formed from a polymer, a hanger bar assembly, a light module, and a trim. A yoke may be installed into the housing to provide greater accessibility to mount the light module and/or trim to the housing. A partition plate may be installed to push back wires/cables disposed in the housing such that the cavity of the housing is divided into a wiring compartment containing the wires/cables and a lighting compartment containing the light module and the trim. A hanger bar assembly may also be coupled to the housing to couple the recessed lighting system to a building structure (e.g., a T-bar, a joist, a stud).

### CROSS-REFERENCE TO RELATED PATENT APPLICATION(S)

This application is a bypass continuation application of International Application PCT/US2019/036477, filed Jun. 11, 2019, and entitled “A POLYMER HOUSING FOR A RECESSED LIGHTING SYSTEM AND METHODS FOR USING SAME,” which claims priority to U.S. Provisional Application No. 62/683,562, filed on Jun. 11, 2018, entitled “PLASTIC DEEP ELECTRICAL JUNCTION BOX,” U.S. Provisional Application No. 62/749,462, filed on Oct. 23, 2018, entitled “PLASTIC DEEP ELECTRICAL JUNCTION BOX,” and U.S. Provisional Application No. 62/791,398, filed on Jan. 11, 2019, entitled “PLASTIC DEEP ELECTRICAL JUNCTION BOX.” Each of the above identified applications is incorporated herein by reference in its entirety.

### BACKGROUND

A recessed lighting system is a lighting device that is installed in an opening on a ceiling or a wall of a building structure in a manner that substantially hides the components of the lighting device (e.g., the housing, the wiring) from view. A typical recessed lighting system includes a light source and a driver deployed in at least one housing (e.g., a can housing, a junction box, or a combination of both). The housing may be coupled to a hanger bar assembly to facilitate installation of the recessed lighting system to various building structures such as a T-bar, a joist, and a stud. The housing may also include a feedthrough to facilitate connection to an external electrical power supply (e.g., an alternating current (AC) or direct current (DC) source in a building). A trim may also be used to cover the opening in the ceiling or the wall. The trim may be designed to modify the lighting in the environment and/or to accommodate aesthetic preferences.

### SUMMARY

The Inventors, via previous innovative designs of lighting systems, have recognized and appreciated that recessed lighting offers several benefits for ambient and task lighting including, but not limited to making the environment appear larger (e.g., low ceiling environments), greater flexibility in tailoring lighting conditions (e.g., wall wash, directional, accent, general lighting), and fewer limitations on the installation location (e.g., a sloped ceiling, a vaulted ceiling, a wall). However, the Inventors have also recognized that previous recessed lighting systems are cumbersome to assemble. Furthermore, the Inventors have recognized previous recessed lighting systems may be expensive due to excessive use of expensive materials and labor costs associated with the manufacture, assembly, and installation of the lighting system.

Previous recessed lighting systems typically include one or more housings (e.g., a can housing, a junction box) to contain the light source and the driver. Additional components may be included such as a mounting pan, metallic conduits, and fittings, which increases the number of parts of the lighting system leading to higher manufacturing costs and a more complex assembly/installation procedure.

The housing(s) is typically formed from a sheet metal. Conventional sheet metal forming processes are limited in terms of fabricating parts with a variable thickness. Thus, the housing(s) typically do not include features to increase the structural rigidity (e.g., a rib, a gusset). Instead, the housing(s) are formed using a thicker material to provide a desired structural integrity at the expense of additional material costs.

Additionally, the recessed lighting system may have to meet certain safety standards (e.g., a fire-rating standard) to operate in the environment. For example, a fire-rating qualification may involve installing a recessed lighting system inside an enclosure (e.g., a fire-rated, thermally insulated enclosure). The enclosure not only increases the complexity of the installation, but also increases the overall size of the lighting system, thus limiting its use in confined spaces (e.g., a ceiling of a multi-family residential building). Alternatively, the housing(s) may be made thicker and/or coated to meet the safety standards, which may add additional costs.

The present disclosure is thus directed to various inventive implementations of a recessed lighting system that is simpler in design and easier to install compared to previous recessed lighting systems while maintaining or, in some instances, improving the mechanical, thermal, and electrical properties of the lighting system. The present disclosure is also directed to various inventive methods of assembling and installing the recessed lighting system described herein.

In one aspect, a housing of the lighting system may be formed from a polymer instead of a metal. A polymer-based housing may be lighter, more flexible in terms of design and manufacturability, and may more readily meet safety standards compared to a metal-based housing. For instance, the housing may be fabricated using injection molding techniques, which enables the integration of structural features to mechanically strengthen the housing (e.g., a rib structure, a section of the housing is thicker than another section). If such features are strategically incorporated into the housing, the housing may be fabricated using less without compromising the structural integrity of the housing. The housing described herein may also replace and/or eliminate several components in previous recessed lighting fixtures including, but not limited to a junction box, a can housing, a mounting pan, metallic conduits, and fittings, thus simplifying the manufacture and assembly of the lighting system.

In another aspect, the lighting system may include a yoke disposed in the cavity of the housing to facilitate the installation of a light module into the housing. The yoke may include a frame with a frame opening through which the light module is partially inserted. The frame may also include features (e.g., a tab with hole) to couple the yoke to the light module. The frame may also include one or more arms that each have a slot. Each arm may be coupled to the housing by inserting a peg, mounted to the housing, through the slot. The yoke may be slidably adjustable along the respective slots of each arm relative to the pegs.

For comparison, in previous housings, the user generally placed their hand inside the cavity of the housing, which may obstruct the user's view making installation more difficult and/or expose the user to safety hazards (e.g., electrical hazard, sharp features). The inclusion of a yoke may mitigate these issues by allowing a user to position the yoke near the opening of the housing or outside of the housing to provide the user a more accessible surface to mount the light module. The yoke may also be formed from a polymer or a metal.

In yet another aspect, the lighting system may include a partition plate disposed in a cavity of the housing to improve the ease of installation by pressing back wires/cables in the housing, which could otherwise obstruct or interfere with the installation of the light module and/or trim. The partition plate may divide the cavity into a wiring compartment and a lighting compartment. The wiring compartment may house one or more wires/cables in the housing to supply/transfer power from an external electrical power source or another recessed lighting system (e.g., a daisy-chained lighting fixture). The lighting compartment may be used to house a light module that includes the light source and the driver. The one or more wires/cables may be fed through a feedthrough in the partition plate to connect to the light module. The partition plate may be secured to the housing in a tool-less manner via a twist and lock connector. The partition plate may also be formed from a polymer or a metal. Furthermore, the partition plate may also reduce the risk of exposure to electrical safety hazards, increase the structural integrity of the housing, and increase heat dissipation from the light module.

In yet another aspect, the lighting system may include a trim to cover an exposed opening in the building structure through which the recessed lighting system is installed. The trim may be coupled to the light module in a tool-less manner, such as through use of a twist and lock connector. The trim may also be secured to the housing using various coupling mechanisms including, but not limited to a spring clip and a clamp. In this manner, the installation of the light module into the housing may be accomplished without the use of any tools, thus reducing the number of parts for installation as well as improving the overall ease of installation of the recessed lighting system.

In one example, a lighting system includes a housing with a sidewall that defines a cavity and an opening at a first end of the sidewall where the cavity contains a light source and a driver, a cover coupled to the sidewall to enclose a second end of the sidewall opposite from the first end, a knockout disposed on at least one of the sidewall or the cover that is removable in order to form a first opening through which a first cable passes through the first opening into the cavity, and a feedthrough tab disposed on at least one of the sidewall or the cover that is sufficiently compliant such that when bent, a second opening is formed through which a second cable passes through the second opening into the cavity.

In another example, a lighting system includes a housing with a sidewall that defines a cavity and an opening at a first end of the sidewall where the cavity contains a light source and a driver, a cover coupled to the sidewall to enclose a second end of the sidewall opposite to the sidewall, and a support section formed on the sidewall proximate to the cover and protruding into the cavity having a support surface to abut at least a portion of a partition plate disposed in the cavity such that a first plane coinciding with a flat side of the partition plate is substantially parallel to a second plane coinciding with the opening of the housing.

In yet another example, a lighting system includes a housing with a sidewall that defines a cavity and an opening at a first end of the sidewall, a cover coupled to the sidewall to enclose a second end of the sidewall opposite from the first end, a knockout disposed on at least one of the sidewall or the cover that is removable to form a first opening through which a conduit cable passes through the first opening into the cavity, a feedthrough tab disposed on at least one of the sidewall or the cover that is sufficiently compliant such that when bent, a second opening is formed through which a Romex cable passes through the second opening into the cavity, and a support section formed on the sidewall proximate to the cover and protruding into the cavity with a support surface. The lighting system also includes a partition plate disposed in the cavity such that the cavity is divided into a wiring compartment and a lighting compartment. The partition plate includes a base that abuts the support surface of the housing and a first twist and lock connector disposed around the periphery of the base. The lighting system also includes a peg coupled to the sidewall of the housing to engage the first twist and lock connector thereby coupling the partition plate to the housing, a light module disposed in the lighting compartment having a module housing that contains therein a light source and a driver, the module housing having a second twist and lock connector, and a trim to cover an environmental opening in a wall or a ceiling of a building where the recessed lighting system is disposed, the trim having a tab that engages the second twist and lock connector of the module housing thereby coupling the trim to the light module. The lighting system also includes a hanger bar assembly with a hanger bar holder coupled to the sidewall of the housing with a slot that allows the hanger bar assembly to be slidably adjustable along a first axis, the hanger bar holder having a track that defines a second axis, a hanger bar coupled to the track of the hanger bar holder that is slidably adjustable along the second axis, and a hanger bar head coupled to an end of the hanger bar to mount the hanger bar assembly to at least one of a T-bar, a joist, or a stud in the building.

In yet another example, a method of installing a lighting system includes the following steps: A) installing a housing by attaching a hanger bar assembly, coupled to the housing, to at least one of a T-bar, a stud, or a joist in a building, B) inserting a cable into a cavity of the housing through a first opening formed by at least one of B1) removing a knockout on the housing or B2) bending a feedthrough tab on the housing, C) inserting the cable through a feedthrough on a partition plate, and D) inserting the partition plate through a second opening of the housing and securing the partition plate to the housing. The method may further include the following steps: E) connecting the light module to the cable, F) coupling a trim to the light module, and G) inserting the light module and the trim through the second opening into the cavity of the housing, the trim having a coupling member to secure the light module and the trim to the housing, the light module being configured to emit light through the second opening. The method may alternatively include the following steps: H) coupling a stand-off to the partition plate and I) coupling a cover plate to the stand-off, the cover plate substantially covering the second opening of the housing.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF THE DRAWINGS

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally similar and/or structurally similar elements).

FIG. 1A shows a top, front perspective view of an exemplary lighting fixture.

FIG. 1B shows a cross-sectional front perspective view of the lighting fixture of FIG. 1A where a yoke is positioned near the cover of the housing.

FIG. 1C shows a cross-sectional front perspective view of the lighting fixture of FIG. 1B where the yoke is positioned near the opening of the housing.

FIG. 1D-1 shows a cross-sectional top view of the lighting fixture of FIG. 1A where the trim is partially engaged with the light module.

FIG. 1D-2 shows a cross-sectional top, front perspective view of the lighting fixture of FIG. 1D-1.

FIG. 1E-1 shows a cross-sectional top view of the lighting fixture of FIG. 1A where a trim is fully engaged with a light module.

FIG. 1E-2 shows a cross-sectional top, front perspective view of the lighting fixture of FIG. 1E-1.

FIG. 2A shows a top view of the junction box of FIG. 1A.

FIG. 2B shows a bottom view of the junction box of FIG. 2A.

FIG. 2C shows a right-side view of the junction box of FIG. 2A, the left-side view being identical.

FIG. 2D shows a front-side view of the junction box of FIG. 2A, the rear-side view being identical.

FIG. 2E shows a top, front perspective view of the junction box of FIG. 2A.

FIG. 2F shows a bottom, front perspective view of the junction box of FIG. 2A.

FIG. 3A shows a bottom view of the junction box of FIG. 2A with the yoke inserted into the junction box.

FIG. 3B shows a bottom, front perspective view of the junction box of FIG. 3A where the yoke is at a fully recessed position.

FIG. 3C shows a bottom, front perspective view of the junction box of FIG. 3A where the yoke is at a neutral position.

FIG. 3D-1 shows a cross-sectional view of the junction box of FIG. 3A where the yoke is at a neutral position.

FIG. 3D-2 shows a cross-sectional view of the junction box of FIG. 3A where the yoke is at a fully recessed position.

FIG. 4 shows an exploded view of another exemplary lighting fixture.

FIG. 5A shows a top view of a junction box in the lighting fixture of FIG. 4.

FIG. 5B shows a bottom view of the junction box of FIG. 5A.

FIG. 5C shows a right-side view of the junction box of FIG. 5A, the left-side view being identical.

FIG. 5D shows a front-side view of the junction box of FIG. 5A, the rear-side view being identical.

FIG. 5E shows a top, front perspective view of the junction box of FIG. 5A.

FIG. 5F shows a bottom, front perspective view of the junction box of FIG. 5A.

FIG. 6A shows a top view of a yoke in the lighting fixture of FIG. 4.

FIG. 6B shows a bottom view of the yoke in FIG. 6A.

FIG. 6C shows a top, front perspective view of the yoke in FIG. 6A.

FIG. 7A shows a bottom view of the junction box of FIG. 5A with the yoke of FIG. 6A inserted into the junction box.

FIG. 7B shows a bottom, front perspective view of the junction box of FIG. 7A where the yoke is at a fully recessed position.

FIG. 7C shows a bottom, front perspective view of the junction box of FIG. 7A where the yoke is at a neutral position.

FIG. 8A shows an exploded view of another exemplary lighting fixture.

FIG. 8B shows a cross-sectional right perspective view of the lighting fixture of FIG. 8A where the lighting fixture is assembled.

FIG. 9A shows a top view of a junction box in the lighting fixture of FIG. 8A.

FIG. 9B shows a bottom view of the junction box of FIG. 9A.

FIG. 9C shows a right-side view of the junction box of FIG. 9A, the left-side view being identical.

FIG. 9D shows a front-side view of the junction box of FIG. 9A, the rear-side view being identical.

FIG. 9E shows a top, front perspective view of the junction box of FIG. 9A.

FIG. 9F shows a bottom, front perspective view of the junction box of FIG. 9A.

FIG. 10A shows a top view of a partition plate in the lighting fixture of FIG. 8A.

FIG. 10B shows a bottom view of the partition plate in FIG. 10A.

FIG. 10C shows a top, front perspective view of the partition plate in FIG. 10A.

FIG. 11A shows a bottom view of the junction box of FIG. 9A with the partition plate of FIG. 10A inserted into the junction box.

FIG. 11B shows a bottom, front perspective view of the junction box of FIG. 11A where the partition plate is at a fully locked position.

FIG. 12A shows an exploded view of another exemplary lighting fixture.

FIG. 12B shows a cross-sectional right perspective view of the lighting fixture of FIG. 12A where the lighting fixture is assembled.

FIG. 13A shows a top view of a junction box in the lighting fixture of FIG. 12A.

FIG. 13B shows a bottom view of the junction box of FIG. 13A.

FIG. 13C shows a right-side view of the junction box of FIG. 13A, the left-side view being identical.

FIG. 13D shows a front-side view of the junction box of FIG. 13A, the rear-side view being identical.

FIG. 13E shows a top, front perspective view of the junction box of FIG. 13A.

FIG. 13F shows a bottom, front perspective view of the junction box of FIG. 13A.

FIG. 14A shows a top view of a partition plate in the lighting fixture of FIG. 12A.

FIG. 14B shows a bottom view of the partition plate in FIG. 14A.

FIG. 14C shows a top, front perspective view of the partition plate in FIG. 14A.

FIG. 15A shows a bottom view of the junction box of FIG. 13A with the partition plate of FIG. 14A inserted into the junction box.

FIG. 15B shows a bottom, front perspective view of the junction box of FIG. 15A where the partition plate is at a fully locked position.

FIG. 16 shows a cross-sectional right perspective view of another exemplary lighting fixture.

FIG. 17A shows a top view of a partition plate in the lighting fixture of FIG. 16.

FIG. 17B shows a bottom view of the partition plate in FIG. 17A.

FIG. 17C shows a top, front perspective view of the partition plate in FIG. 17A.

FIG. 17D shows a bottom, front perspective view of the partition plate of FIG. 17A.

FIG. 18A shows a bottom view of the junction box of FIG. 13A with the partition plate of FIG. 17A inserted into the junction box.

FIG. 18B shows a bottom, front perspective view of the junction box of FIG. 18A where the partition plate is at a fully locked position.

FIG. 19A shows a bottom view of the junction box of FIG. 13A with the partition plate of FIG. 17A inserted into the junction box and a stand-off coupled to the partition plate.

FIG. 19B shows a bottom, front perspective view of the junction box of FIG. 19A where the partition plate is at a fully locked position and the stand-off is coupled to the partition plate.

FIG. 19C shows an exploded bottom, front perspective view of the junction box and the stand-off of FIG. 19A.

FIG. 19D shows a bottom, front perspective view of the junction box of FIG. 19A and a cover plate.

### DETAILED DESCRIPTION

Following below are more detailed descriptions of various concepts related to, and implementations of, a recessed lighting system configured to be easier to install, simpler in terms of manufacturability, and meets desired mechanical, electrical, and thermal properties during operation. Specifically, a housing and components used to facilitate the installation of a light module in the housing are described herein. It should be appreciated that various concepts introduced above and discussed in greater detail below may be implemented in multiple ways. Examples of specific implementations and applications are provided primarily for illustrative purposes so as to enable those skilled in the art to practice the implementations and alternatives apparent to those skilled in the art.

The figures and example implementations described below are not meant to limit the scope of the present implementations to a single embodiment. Other implementations are possible by way of interchange of some or all of the described or illustrated elements. Moreover, where certain elements of the disclosed example implementations may be partially or fully implemented using known components, in some instances only those portions of such known components that are necessary for an understanding of the present implementations are described, and detailed descriptions of other portions of such known components are omitted so as not to obscure the present implementations.

In the discussion below, various examples of inventive recessed lighting systems are provided, wherein a given example or set of examples showcases one or more particular features of a housing, a yoke, and/or a partition plate. It should be appreciated that one or more features discussed in connection with a given example of a light module and a trim may be employed in other examples of recessed lighting systems according to the present disclosure, such that the various features disclosed herein may be readily combined in a given recessed lighting system according to the present disclosure (provided that respective features are not mutually inconsistent).

### A First Example of a Recessed Lighting System with a Yoke

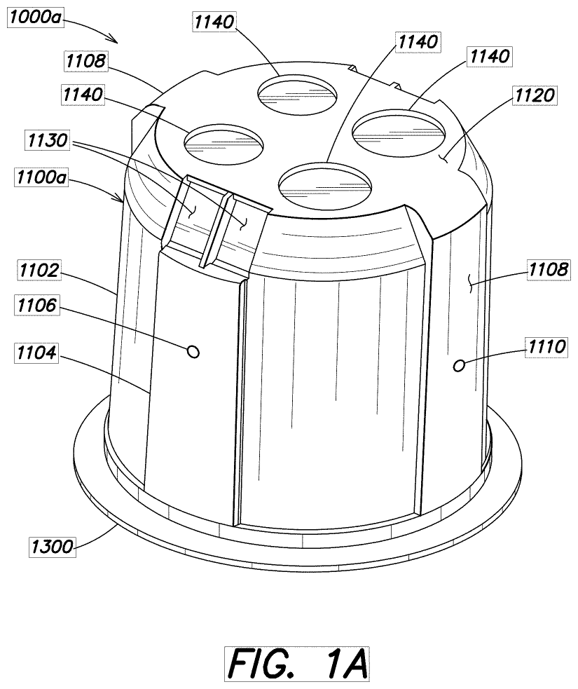

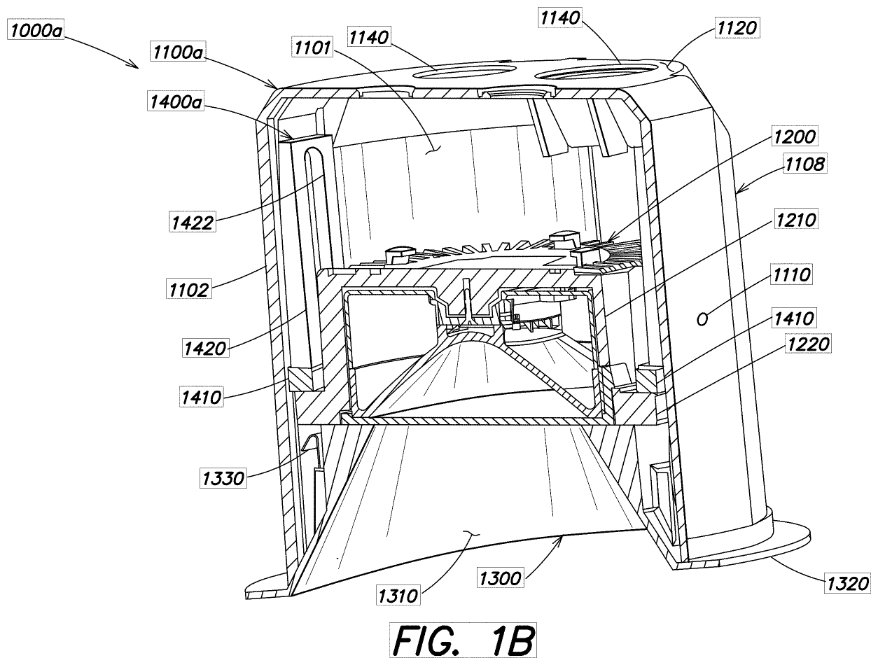

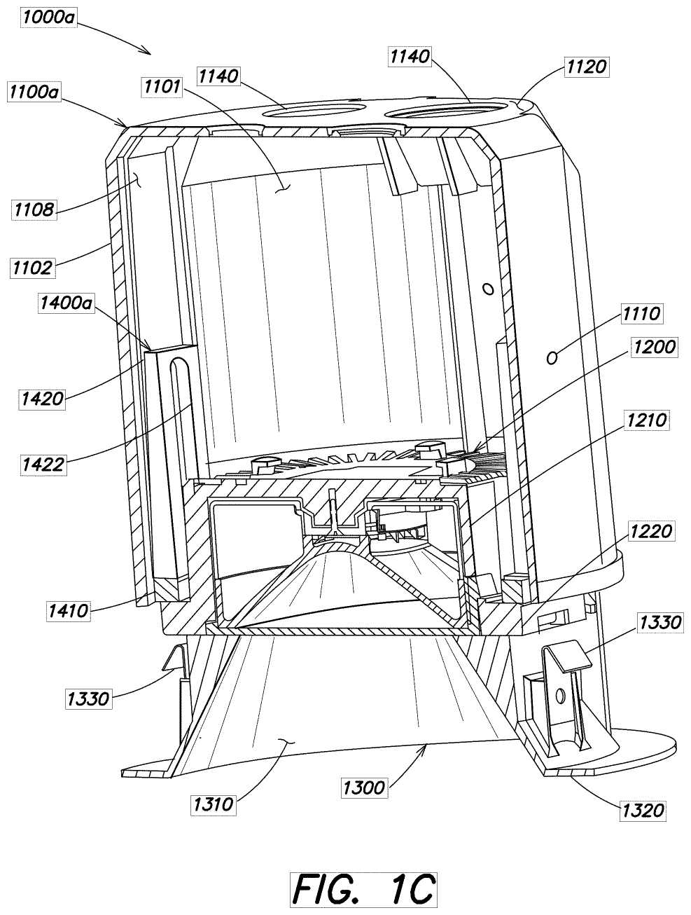

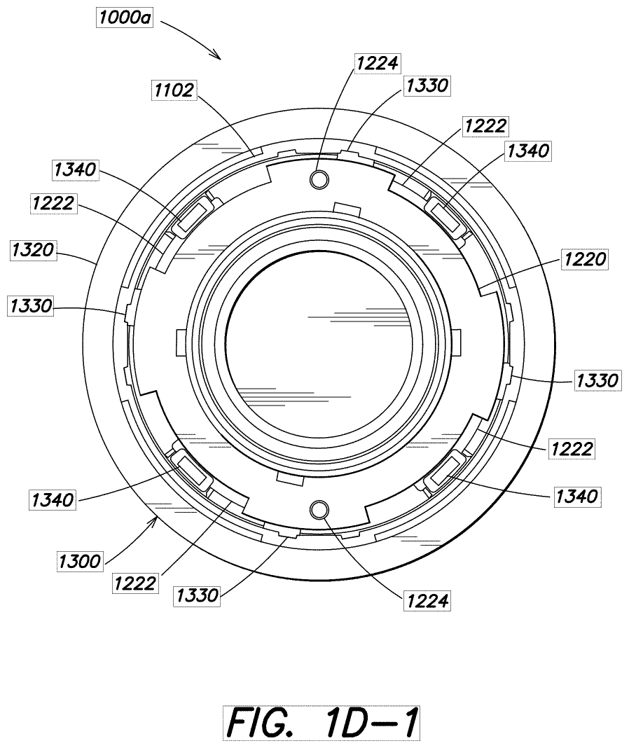

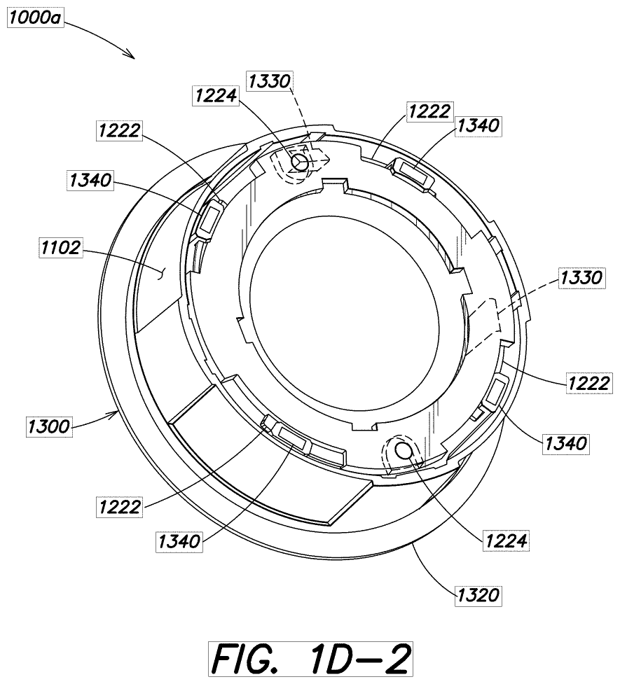

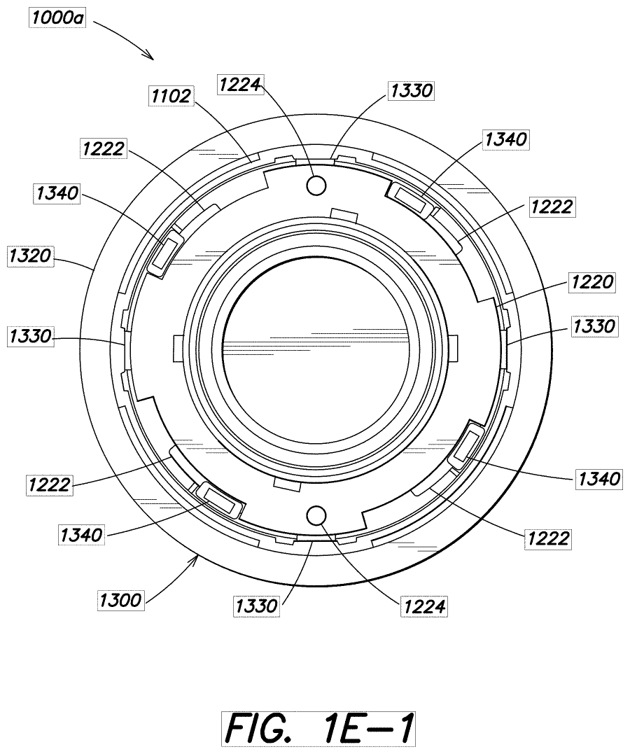

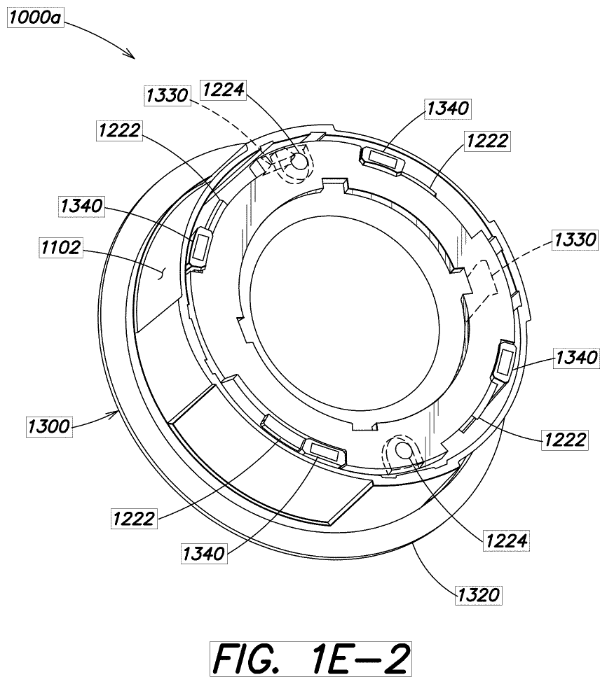

FIGS. 1A-1E show several views of an exemplary recessed lighting system 1000a with a yoke 1400a. As shown, the lighting system 1000a may include a housing 1100a with a cavity 1101 that contains a light module 1200 and a yoke 1400a. The housing 1100a may include an opening 1103 for light from the light module 1200 to pass through into the environment. The light module 1200 may include a light source to emit light and a driver to supply power to the light source. Thus, the housing 1100a may replace the can housing and the junction box used in previous recessed lighting systems. The housing 1100a may also eliminate the use of a mounting pan and additional cables (e.g., metallic conduits) previously used to connect the junction box and the can housing.

Additionally, a trim 1300 may also be disposed, at least in part, onto the opening 1103 of the housing 1100a to cover a corresponding opening in the ceiling or wall of the building structure into which the recessed lighting system 1000a is installed. The recessed lighting system 1000a may be mounted to various structures in the building (e.g., a stud, a joist, a T-bar) via a hanger bar assembly (not shown). The hanger bar assembly may provide multiple axes of adjustment in order to position the recessed lighting system 1000a at a desired location relative to the structures supporting the recessed lighting system. An exemplary hanger bar assembly is described in further detail below with respect to other exemplary recessed lighting systems 1000 (e.g. recessed lighting systems 1000a-1000e).

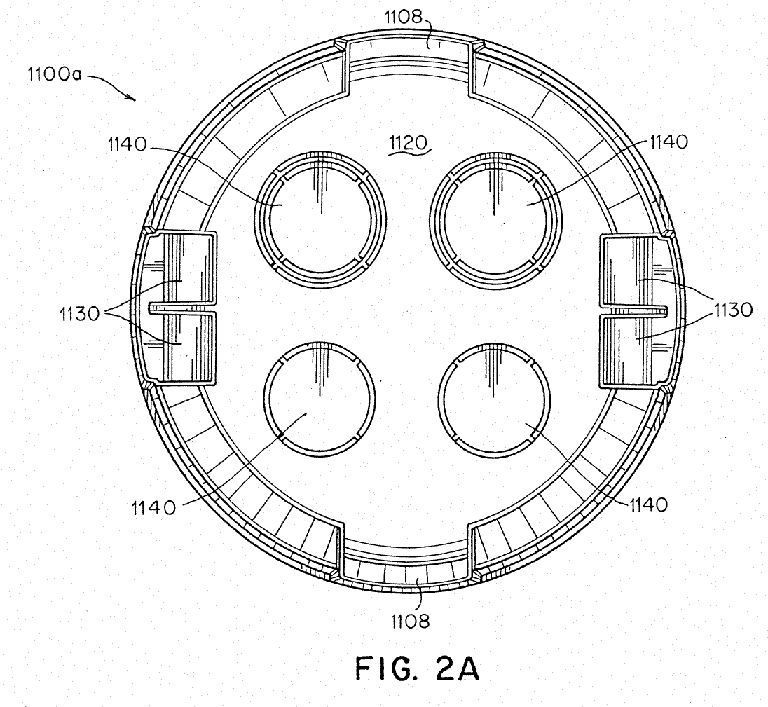

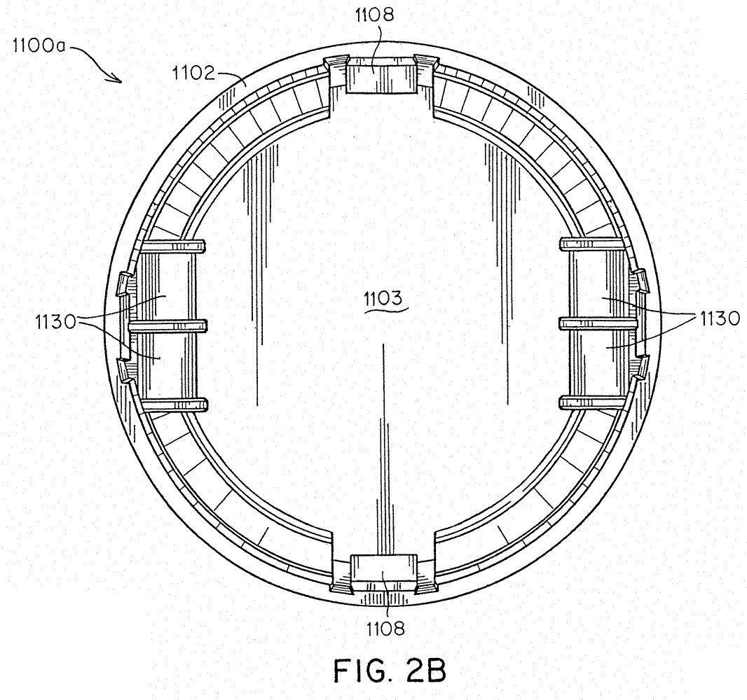

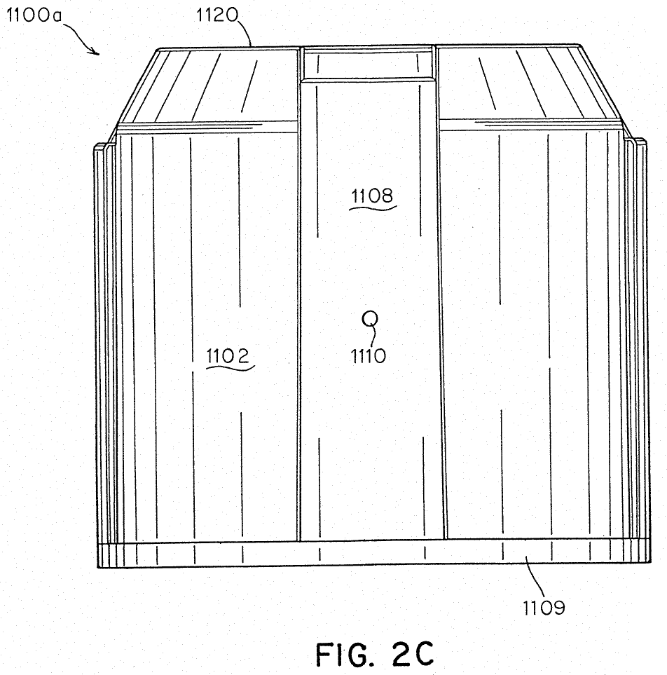

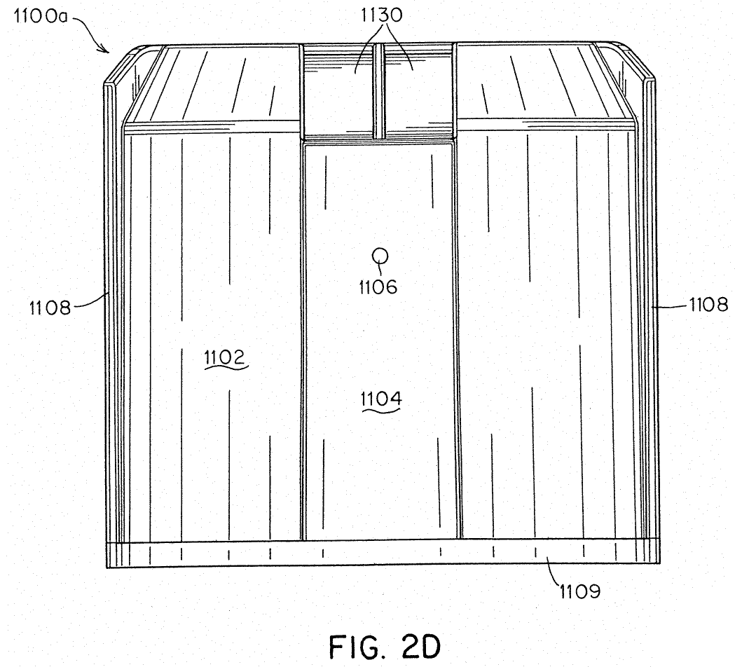

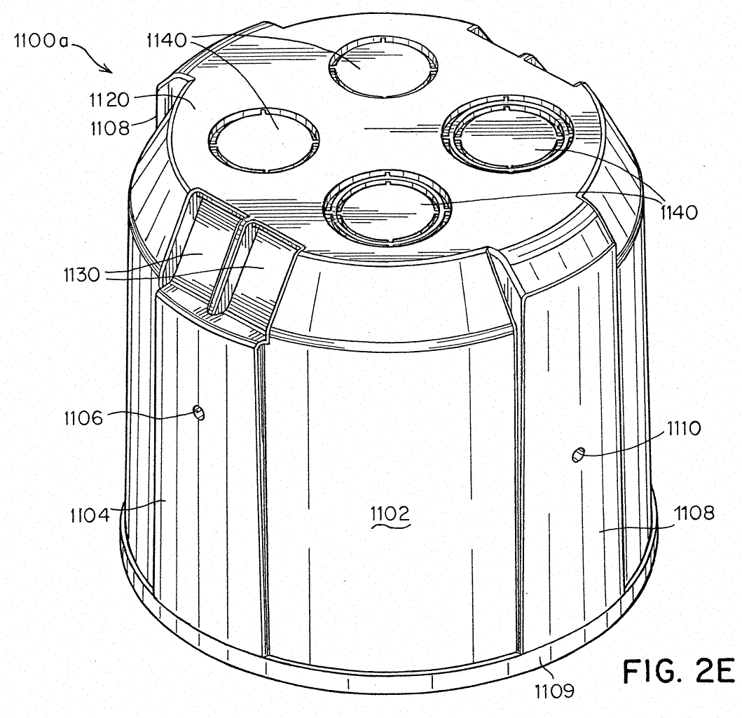

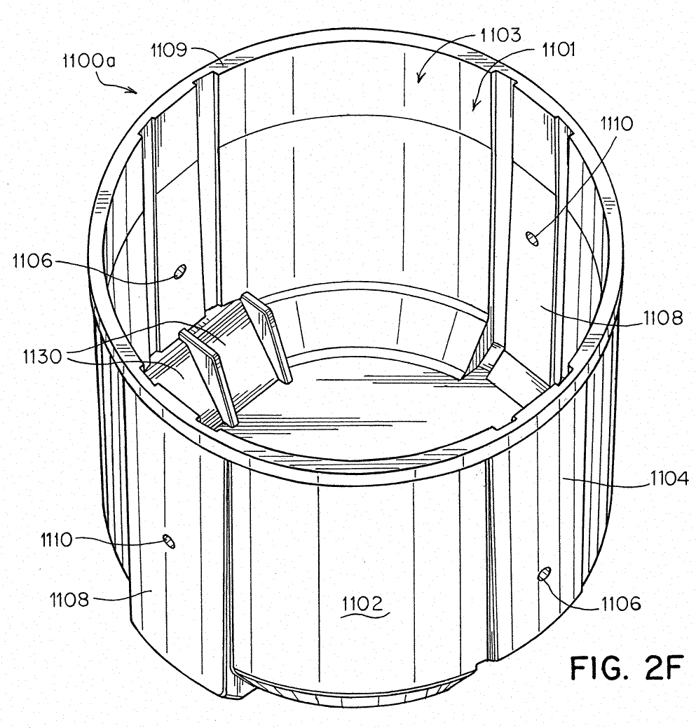

As shown in FIGS. 1B and 1C, the yoke 1400a is slidably adjustable along a slot 1422 on an arm 1420 of the yoke 1400a. The slot 1422 of the yoke 1400a may thus define the limits in the position of the yoke 1400a relative to the housing 1100a. FIG. 1B shows one exemplary limit where the yoke 1400a may be fully recessed into the cavity 1101 of the housing 1100a such that the light module 1200 and a portion of the trim 1300 is also contained in the cavity 1101 of the housing 1100a. FIG. 1C shows another exemplary limit where the frame 1410 of the yoke 1400a abuts the opening 1103 of the housing 1100a for the user to more easily mount the light module 200 to the yoke 1400a. FIGS. 1D-1E show the trim 1300 may be secured to the light module 1200 via at least one tab 1340 on the trim 1300 that engages a twist and lock connector 1222 on a module housing 1210 of the light module 1200. In particular, FIGS. 1D-1 and 1D-2 show cross-sectional views of the recessed lighting system 1000a where the tab 1340 of the trim 1300 is partially engaged with the twist and lock connector 1222 of the light module 1200. FIGS. 1E-1 and 1E-2 show cross-sectional views of the recessed lighting system 1000a where the tab 1340 of the trim 1300 if fully engaged with the twist and lock connector 1222 of the light module 1200.

Generally, a method of installing the recessed lighting system 1000a may include the following steps: (1) installing the housing 1100a into the building structure using the hanger bar assembly, (2) removing a knockout 1140 and/or opening a feedthrough tab 1130 to pass a wire or cable that supplies electrical power to the light module 1200 into the cavity 1101 of the housing 1100a, (3) configuring the wire/cable for connection (e.g., attaching a connector, connecting a ground wire to an electrical ground), (4) electrically coupling the light module 1200 to the wire/cable, (5) mounting the light module 1200 to the frame 1410 of the yoke 1400a, (6) mounting the trim 1300 to the light module 1200, (7) inserting the light module 1200, trim 1300, and yoke 1400a into the cavity 1101 of the housing 1100a along the axis defined by the slot 1422 on the arm 1420 of the yoke 1400a. The trim 1300 may include a coupling mechanism, such as a friction spring clip, to secure the light module 1200, trim 1300, and yoke 1400a to the housing 1100a.

FIGS. 2A-2F show several exemplary views of the housing 1100a. As shown, the housing 1100a may include a sidewall 1102 that defines and substantially surrounds a cavity 1101. The sidewall 1102 may have an opening 1103 through which light from the light module 1200 exits the recessed lighting system 1000a into the environment. The sidewall 1102 may also include a cover 1120 to partially enclose the housing 1100a. As shown in FIGS. 2A-2F, the sidewall 1102 may define a radially symmetric cavity 1101 along a linear axis. It should be appreciated that the housing 1100a in other implementations may define an asymmetric cavity 1101. The cover 1120 may thus be disposed at an opposing end of the sidewall 1102 from the opening 1103. In some implementations, the cover 1120 and the sidewall 1102 may be formed as a single component to reduce the number of manufacturing steps and to simplify assembly. In some implementations, the cover 1120 and the sidewall 1102 may be an assembly of multiple components that are coupled together using various coupling mechanisms including, but not limited to a snap fit, a fastener, a clip, and a clamp. Fabricating the cover 1120 and the sidewall 1102 separately may simplify manufacture by simplifying the complexity of the parts being fabricated.

The sidewall 1102 and the cavity 1101 may generally have various cross-sectional shapes including, but not limited to a circle, an ellipse, a regular polygon (e.g., a polygon where the sides are equal in length), and an irregular polygon (e.g., a polygon where the sides are not equal in length). In one example, the sidewall 1102 and the cavity 1101 may have a circular cross-section, which may reduce the size of the flange 1320 on the trim 1300 to cover the opening 1103 of the housing 1100a. In another example, the sidewall 1102 may have an irregular octagonal cross-section such that the shape of the housing 1100a may appear as a tapered square (e.g., a square with chamfered or beveled corners). In some implementations, the cross-sectional shape of the sidewall 1102 and/or the cavity 1101 may vary along an axis orthogonal to the opening 1103 or between the cover 1120 and the opening 1103 (e.g., along the length of the sidewall 1102). For example, the cross-sectional shape of the sidewall 1102 may be polygonal near the cover 1120 and cylindrical near the opening 1103. Additionally, the housing 1100a and the cavity 1101 may have a similar shape (e.g., the sidewall 1102 is substantially uniform) or a dissimilar shape (e.g., the sidewall 1102 is substantially non-uniform). For example, the sidewall 1102 and the cavity 1101 of the housing 1100a in FIGS. 2A-2F may both have a cross-sectional shape that is cylindrical. In another example, the sidewall 1102 may be polygonal and the cavity 1101 is cylindrical. This may result in a sidewall 1102 with a variable thickness. Furthermore, the cover 1120 may have a shape substantially similar to the cross-sectional shape of the sidewall 1102 (e.g., the circular cover 1120 and the circular sidewall 1102 shown in FIGS. 2A-2F) or a shape that is dissimilar to the sidewall 1102 (e.g., a circular cover 1120 and a polygonal sidewall 1102 such that the cover 1120 has an overhanging portion).

The housing 1100a may also include a bevel and/or a chamfer between the cover 1120 and the sidewall 1102 to reduce the amount of material used, the presence of sharp corners for safety and wear resistance, and/or to improve manufacturability. The housing 1100a may also incorporate structural features to increase the structural rigidity of the housing 1100a. For example, FIG. 2E shows the sidewall 1102 include mounting sections 1104 and 1108 to facilitate coupling to a hanger bar assembly and the yoke 1400a, respectively. These sections 1104 and 1108 may be made thicker than other portions of the sidewall 1102 to increase the structural rigidity of the sidewall. Additionally, the housing 1100a may have a rim 1109 at the opening 1103 to also increase structural rigidity.

In some implementations, the housing 1100a may be dimensioned to accommodate the light module 1200 and wires/cables that supply or transfer electrical power to or from the recessed lighting system 1000a. For instance, the housing 1100a may have a depth of up to about 4 inches and a width (or a diameter) ranging between about 2 inches and about 6 inches. The housing 1100a may also be dimensioned such that the cavity 1101 has sufficient volume to contain multiple wires/cables with a gauge at least about 12 or greater (e.g., a higher gauge corresponds to a smaller sized wire/cable). For example, the cavity 1101 may provide sufficient room to contain eight 12 gauge wires/cables to daisy-chain the recessed lighting system 1000a with another lighting system in the environment (e.g., another recessed lighting system 1000a). Said in another way, a portion of the cavity 1101 of the housing 1100a may be dedicated to house wires/cables with a corresponding volume similar to previous electrical junction boxes (e.g., between about 15 cubic inches to about 30 cubic inches). Additionally, the housing 1100a may have sufficient volume to contain therein the light module 1200 and at least a portion of the trim 1300.

The housing 1100a may also include several features to facilitate assembly with other components of the recessed lighting system 1000a. For example, the housing 1100a may include a knockout 1140, which is a removable portion of the housing 1100a that creates an opening for a wire/cable, such as a conduit cable (e.g., a metallic sheathed cable) to enter or exit the cavity 1101 of the housing 1100a. FIGS. 2A and 2E show the cover 1120 of the housing 1100a may include multiple knockouts 1140. As shown, the knockouts 1140 may vary in size and shape. Furthermore, the knockout 1140 may have multiple removable portions (e.g., a central portion and an annular portion) to allow the user to progressively enlarge the opening. Although FIGS. 2A and 2E show the knockouts 1140 are only on the cover 1120, it should be appreciated the knockout 1140 may also be disposed on other portions of the housing 1100a (e.g., the sidewall 1102). In some implementations, the knockout 1140 may satisfy a pull force specification for a conduit cable set forth by the National Electric Code (NEC).

In another example, the housing 1100a may include a feedthrough tab 1130 to facilitate entry of a wire/cable, such as a Romex cable (i.e., a non-metallic sheathed cable). Unlike the knockout 1140 described above, the feedthrough tab 1130 may be a non-removable, compliant feature that allows a user to form an opening by bending the feedthrough tab 1130 into the cavity 1101 of the housing 1100a. FIGS. 2A-2E show several exemplary feedthrough tabs 1130 disposed on the beveled portion of the housing 1100a between the sidewall 1102 and the cover 1120. In some implementations, the feedthrough tab 1130 may allow a user to open and close openings in the housing 1100a by bending the feedthrough tab 1130 into and out of the cavity 1101. The portion of the feedthrough tab 1130 that attaches to the sidewall 1102 may also be prestressed during manufacture such that a restraining force is applied to the wire/cable, thus holding the wire/cable in place in the housing 1100a after installation. If a wire/cable is subsequently removed from the housing 1100a, the restraining force may cause the feedthrough tab 1130 to return to its original closed position. In some implementations, the feedthrough tab 1130 may satisfy a pull force specification for a Romex cable set forth by the National Electric Code (NEC).

It should be appreciated the wire/cable (e.g., the conduit cable, the Romex cable) supplying electrical power to the recessed lighting system 1000a may be an alternating current (AC) source or a direct current source (DC). It should also be appreciated the wire/cable may originate from an electric power supply in the building structure or from another recessed lighting system 1000a in a daisy-chaining configuration.

The housing 1100a may also include structural features to couple the yoke 1400a to the housing 1100a. For example, FIGS. 2C, 2E, and 2F show the housing 1100a includes the mounting section 1108, which protrudes outwards from the sidewall 1102. The mounting section 1108 may be protruded in order to define a corresponding recess in the cavity 1101 that mechanically guides the arm 1420 of the yoke 1400a as the yoke 1400a slides along the slot 1422. The mounting section 1108 may also include an opening 1110 to receive a coupling member (not shown) that passes, at least partially, through the opening 1110. The coupling member may be inserted into the slot 1422 of the arm 1420 of the yoke 1400a to constrain and guide the yoke 1400a. The coupling member may be various type of coupling mechanisms including, but not limited to a peg, a screw fastener, a bolt fastener, a dowel, and a rod. In some implementations, the coupling member may be tightened (e.g., via a nut, a thumbscrew, a butterfly wing screw) to secure the yoke 1400a to the housing 1100a at a particular position along the slot 1422. In some implementations, the coupling member may not secure the yoke 1400a to the housing 1100a, but instead may only guide the yoke 1400a. In such designs, another mechanism (e.g., a friction spring clip on the trim 1300) may be used to secure the yoke 1400a (along with the light module 1200 and the trim 1300) to the housing 1100a.

The housing 1100a may also include structural features to couple the hanger bar assembly to the housing 1100a. For example, FIGS. 2D, 2E, and 2F show the housing 1100a includes the mounting section 1104, which protrudes outwards from the sidewall 1102 to provide a surface against which a hanger bar holder of the hanger bar assembly may be mounted to the housing 1100a. The mounting section 1104 may include an opening 1106 to couple the hanger bar holder to the housing 1100a via a coupling member (not shown). The coupling member may again be various type of coupling mechanisms including, but not limited to a screw fastener, a bolt fastener, and a snap fit. As will be described in further detail below, the position of the hanger bar assembly relative to the housing 1100a may be adjustable to accommodate different building structures (e.g., the spacing and orientation between neighboring studs may vary) in the environment.

The housing 1100a may also be configured to satisfy one or more safety standards related to various properties of the recessed lighting system 1000a including, but not limited to fire resistance, sound attenuation, air tightness, concrete tightness, structural rigidity, and water resistance. For example, the housing 1100a may be qualified as a luminaire fixture and/or a junction box based on the specifications set forth by the NEC and/or the Underwriter's Laboratory (UL). For instance, the housing 1100a may be qualified as a junction box if the housing 1100a satisfies UL514C, which is the UL standard for nonmetallic outlet boxes, flush-device boxes, and covers. The housing 1100a may be qualified as a luminaire fixture if the housing 1100a satisfies UL1598, which is the UL standard for luminaires.

The housing 1100a may generally be fire-rated or non-fire-rated depending on the material used to form the housing 1100a and the gage or thickness of the housing 1100a. In terms of safety standards, the housing 1100a may be fire-rated if the housing 1100a satisfies UL263, which is the UL standard for fire tests of building construction and materials, or the standards set forth by the American Society for Testing and Materials (ASTM) and/or the National Fire Protection Association (NFPA). For instance, the housing 1100a may have an hourly rating (e.g., 1 hour, 2 hour) and a location rating (e.g., floor, wall, ceiling) based on where the recessed lighting system 1000a is installed in the environment.

As described above, the housing 1100a may also incorporate structural features to improve the structural rigidity of the housing 1100a. The design of such features may be based, in part, on structural rigidity specifications set forth by the NEC and/or the UL (e.g., UL 1598, UL 541C) for a junction box and a luminaire fixture. The housing 1100a may also be insulation contact (IC) rated, which allows insulation in a wall or a ceiling to physically contact the housing 1100a. An IC rated housing 1100a may enable the recessed lighting system 1000a to be installed without use of a separate enclosure unlike non-IC rated recessed lighting systems. The housing 1100a may also meet air tightness standards (e.g., ASTM E283 certification) to increase the energy efficiency of a building by reducing air leaks between an interior environment and an exterior environment that may otherwise compromise the thermal insulation of the building. The housing 1100a may also meet sound ratings according to the specifications set forth by the Sound Transmission Class (STC) and/or the Impact Insulation Class (IIC).

It should be appreciated the safety standards cited herein are exemplary. The recessed lighting system 1000a may generally satisfy similar and/or equivalent safety standards from other organizations and/or associations, which may vary by municipality, county, state, province, or country. Furthermore, the recessed lighting system 1000a may satisfy the specifications set forth by safety standards as they are modified and/or updated over time.

The housing 1100a may be formed from various thermoplastic and thermosetting polymers including, but not limited to polyvinyl chloride (PVC), acrylonitrile butadiene styrene (ABS), polycarbonate (PC), polyurethane (PU), polyethylene, polyethylene terephthalate, polypropylene, and polystyrene. The housing 1100a may be fabricated using various manufacturing methods including, but not limited to injection molding, 3D printing, and blow molding.

As described above, the yoke 1400a may be used to facilitate the installation of the light module 1200 into the housing 1100a by providing a user a more accessible surface to mount the light module 1200 to the housing 1100a. In some implementations, the yoke 1400a may not be removable from the housing 1100a once the coupling member is inserted into the opening 1106 of the mounting section 1104 through the slot 1422. In this manner, the yoke 1400a may also function as a safety feature of the recessed lighting system 1000a by preventing the light module 1200 from inadvertently falling out of the cavity 1101 of the housing 1100a. In some implementations, the yoke 1400a may also allow the light module 1200 to be tilted within the cavity 1101 of the housing 1100a in order to adjust the direction of the light from the light module 1200 into the environment. For example, the coupling member in the opening 1106 may function as a pivot, allowing the yoke 1400a to rotate about the coupling member. The orientation of the light module 1200 may be maintained by tightening the coupling member to secure the yoke 1400a to the housing 1100a and/or using a trim 1300 with an opening 1310 shaped to support the tilted orientation of the light module 1200.

The yoke 1400a may include a frame 1410 that defines a frame opening 1430. The frame 1410 and the frame opening 1430 may have various shapes including, but not limited to a circle, an ellipse, a regular polygon, and an irregular polygon. In some implementations, the frame 1410 may have an irregular thickness such that the exterior shape of the frame 1410 and the frame opening 1430 are different. For example, the exterior shape of the frame 1410 may be polygonal and the frame opening 1430 may be circular. In some implementations, the exterior shape of the frame 1410 may correspond to the shape of the cavity 1101 of the housing 1100a and the shape of the frame opening 1430 may correspond to the shape of the module housing 1210 of the light module 1200. In this manner, the frame 1410 may substantially enclose a portion of the cavity 1101 of the housing 1100a when the light module 1200 is installed. Furthermore, the frame 1410 may be shaped to abut against a portion of the module housing 1210.

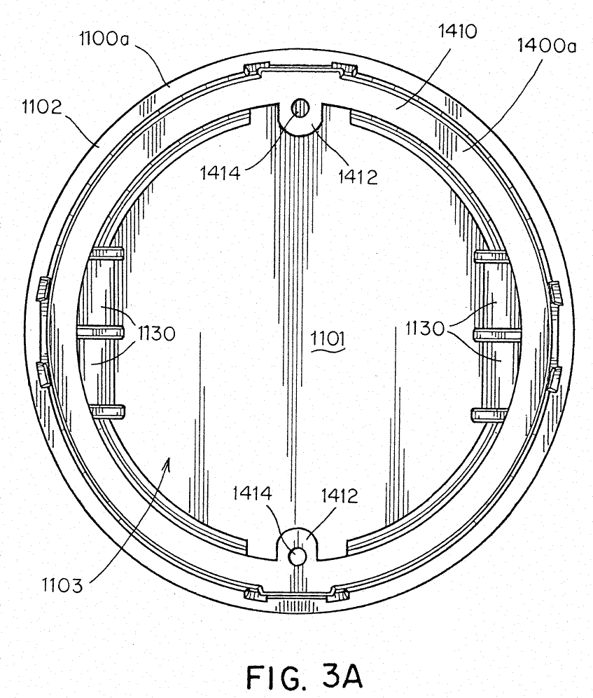

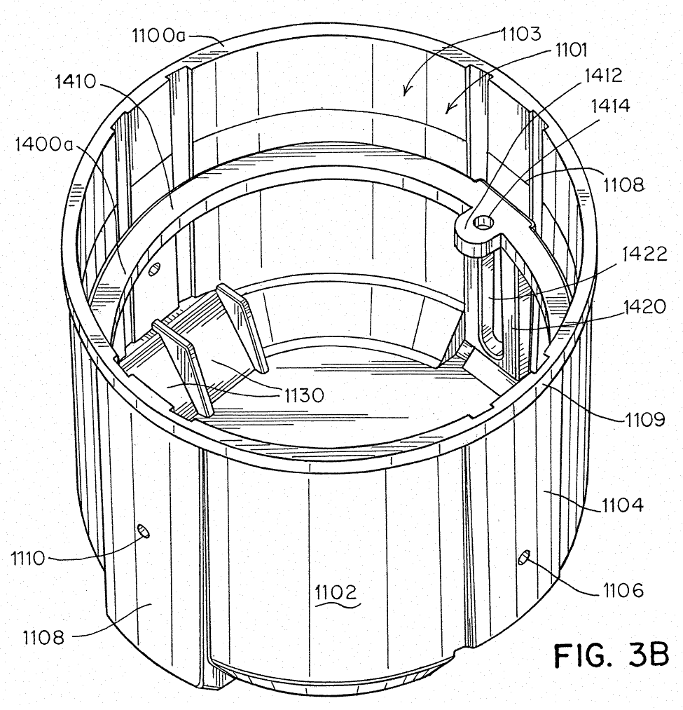

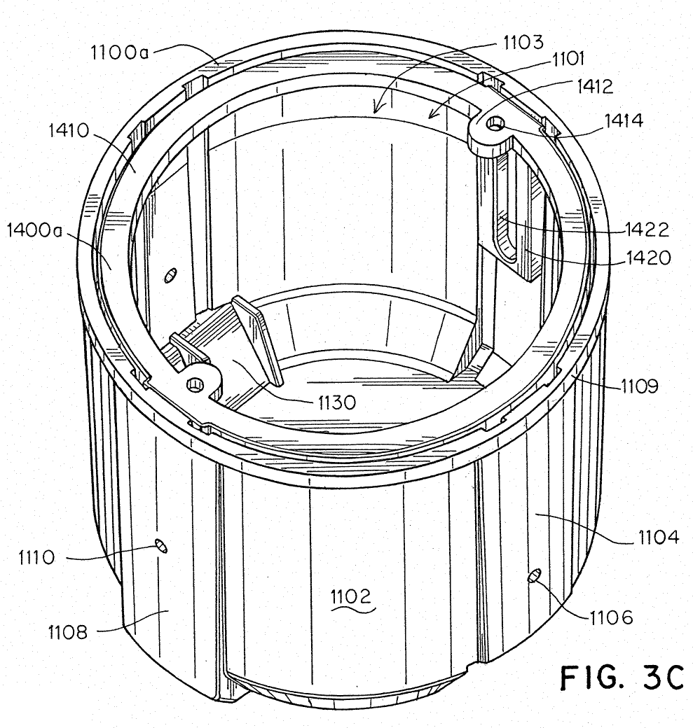

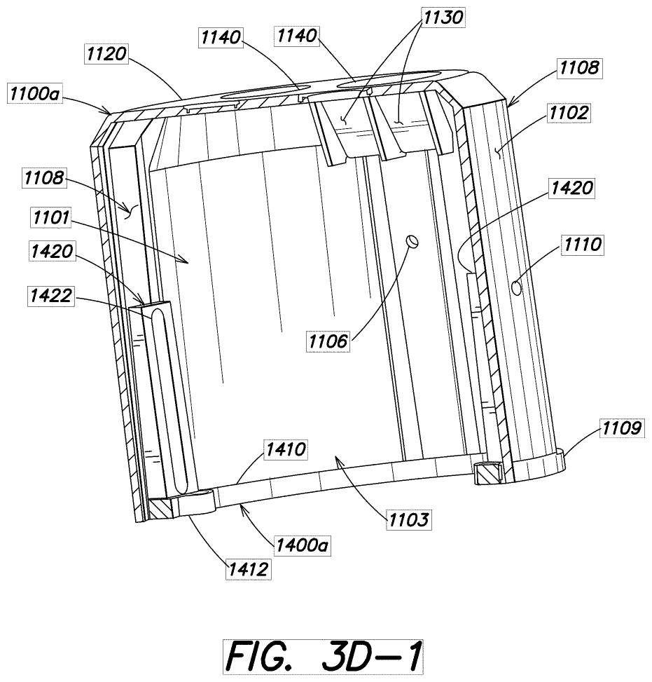

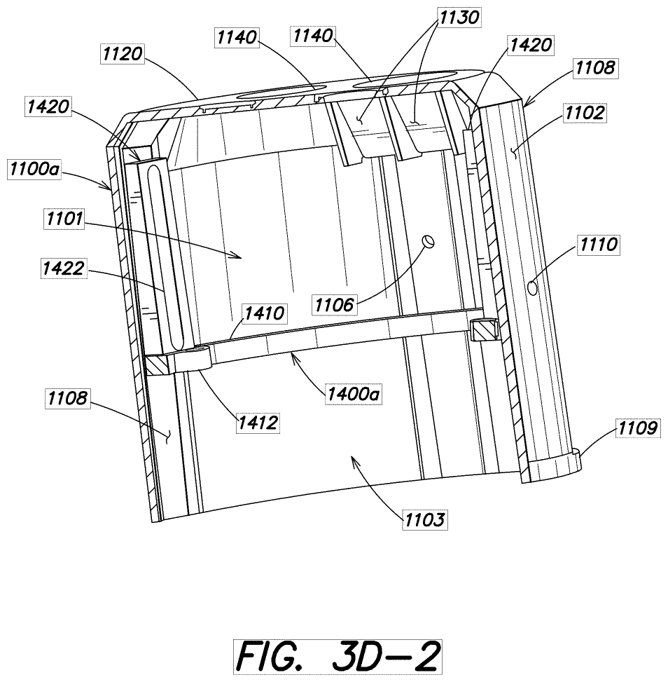

The frame 1410 may also include various coupling mechanisms to couple the light module 1200 to the yoke 1400a including, but not limited to a screw fastener, a bolt fastener, and a snap fit connector. FIGS. 3A-3C show several views of an exemplary yoke 1400a deployed in the housing 1100a. As shown, the yoke 1400a may include a tab 1412 that extends into the frame opening 1430. The tab 1412 may be used to define an opening 1414 where a fastener may be inserted through the opening 1414 to couple the yoke 1400a to the module housing 1210. As shown, the yoke 1400a may include multiple openings 1414 arranged to match corresponding openings on the module housing 1210 for assembly. The frame opening 1430 may also be dimensioned such that the light module 1200 is at least partially inserted through the frame opening 1430. For instance, FIGS. 1B and 1C show the module housing 1210 is partially inserted through the frame opening 1430 such that a flange 1220 on the module housing 1210 abuts the frame 1410. The flange 1220 may include through hole openings 1224 aligned to the openings 1414, which in this case may be threaded to secure respective fasteners.

The yoke 1400a may also include an arm 1420 attached to the frame 1410. The arm 1420 may protrude from the frame 1410 along an axis substantially orthogonal to a plane coincident with the frame opening 1430. For example, the yoke 1400a depicted in FIGS. 3B-3D-2 has a flat, circular frame 1410. Thus, a plane may be defined based on the frame opening 1430 that is substantially parallel to the opening 1103 of the housing 1100a. The arm 1420 may protrude along an axis normal to the plane. Said in another way, the arm 1420 may include a proximal end coupled to the frame 1410 and a distal end that is positioned some distance (e.g., the length of the arm 1420) from the proximal end. The linear axis defined between the proximal end and the distal end may be normal to the plane defined by the frame opening 1430.

The arm 1420 may also include a slot 1422 that runs along the length of the arm 1420. The slot 1422, as described above, may define the translational axis along which the yoke 1400a is slidably adjustable. The length of the slot 1422 may determine the range of translational motion of the yoke 1400a with respect to the housing 1100a. The position of the slot 1422 in relation to the arm 1420 and the opening 1106 may determine the available positions of the yoke 1400a within the cavity 1101 of the housing 1100a. For example, FIGS. 3C and 3D-1 show the yoke 1400a may be configured such that at one limit, the frame 1410 of the yoke 1400a abuts the opening 1103 of the housing 1100a such that the frame 1410 does not extend beyond the opening 1103. FIGS. 3B and 3D-2 show another limit where the distal end of the arms 1420 are proximate to the cover 1120 of the housing 1100a. The width of the slot 1422 may correspond to the size of the opening 1110 and/or the size of the coupling member mounted to the opening 1110.

The yoke 1400a may be formed from various metals, thermoplastic polymers, and thermosetting polymers including, but not limited to aluminum, steel, stainless steel, polyvinyl chloride (PVC), acrylonitrile butadiene styrene (ABS), polycarbonate (PC), and polyurethane (PU), polyethylene, polyethylene terephthalate, polypropylene, polystyrene, a Makrolon® polycarbonate, and a Therma-Tech™ thermally conductive compound. The yoke 1400a may be fabricated using various manufacturing methods including, but not limited to injection molding, 3D printing, blow molding, casting, and machining.

The light module 1200 may include the module housing 1210, which defines a cavity 1101 that contains various components of the light module 1200 including the light source and the driver. The light source emits light and the driver is used to supply and regulate electrical power to the light source. In some implementations, the module housing 1210 may also house various optical elements that modify the spatial and angular distribution of the light outputted from the light source including, but not limited to a reflector, a lens, a diffuser, and a protective cover.

The module housing 1210 may thus be an enclosure with an opening that outputs light from the light source. The module housing 1210 may include a plurality of fins to facilitate convective cooling. The module housing 1210 may also include a flange 1220 defined along the periphery of the opening of the module housing 1210. The flange 1220 may abut the frame 1410 as shown in FIGS. 1B and 1C. The flange 1220 may also contain various structural features to couple the light module 1200 to the yoke 1400a and/or the trim 1300. For example, FIGS. 1D-1-1E-2 show the flange 1220 may include a twist and lock connector 1222 to connect to a tab 1340 on the trim 1300. As described above, the flange 1220 may also include openings 1224 that align with the openings 1414 on the frame 1410 of the yoke 1400a.

The module housing 1210 may also be used to dissipate heat generated by the light source. In cases where insulation in the building structure substantially covers the housing 1100a, the heat may be dissipated along several paths including: (1) from the module housing 1210 directly to the environment via convective cooling and/or (2) from the module housing 1210 to the trim 1300 via heat conduction and then to the environment via convective cooling. If the recessed lighting system 1000a is deployed in a building structure with open space around the housing 1100a, heat may also be dissipated along a path (3) from the housing 1100a to the open space via convection.

The module housing 1210 may be formed from a combination of various metals and polymers including, but not limited to aluminum, steel, stainless steel, copper, polyvinyl chloride (PVC), acrylonitrile butadiene styrene (ABS), polycarbonate (PC), polyurethane (PU), polyethylene, polyethylene terephthalate, polypropylene, polystyrene, a Makrolon® polycarbonate, and a Therma-Tech™ thermally conductive compound. In some implementations, the module housing 1210 may be formed via an overmolding process where a portion of the module housing 1210 made of a first material (e.g., a metal) is then covered by a second material (e.g., a polymer) to form a unitary component.

Exemplary implementations of the light module 1200 may also be found in PCT Application PCT/US19/32281, filed May 14, 2019 and entitled, “LIGHTING MODULE HAVING INTEGRATED ELECTRICAL CONNECTOR,” which is incorporated by reference herein in its entirety.

The trim 1300 may be used to cover the opening 1103 of the housing 1100a and an opening in a ceiling or a wall on the building structure where the recessed lighting system 1000a is installed. As shown in FIGS. 1A-1C, the trim 1300 may include an opening 1310 where light from the light module 1200 exits the recessed lighting system 1000a and into the environment. The trim 1300 may also include a flange 1320 disposed along the periphery of the opening 1310 shaped to cover the opening of the ceiling or wall. The opening 1310 may be tapered such that the opening 1310 is conical in shape (e.g., frusto-conical). The flange 1320 and the cross-sectional shape of the opening 1310 may have various shapes including, but not limited to a circle, an ellipse, a regular polygon, and an irregular polygon.

The trim 1300 may also include various features to couple the trim 1300 to the light module 1200 and/or the housing 1100a. For example, the trim 1300 may include tabs 1340 that engage with the twist and lock connector 1222 of the light module 1200. The trim 1300 may also include a coupling member 1330 to couple the trim 1300 to the sidewall 1102 of the housing 1100a in the cavity 1101. The coupling member 1330 may be various coupling mechanisms including, but not limited to a friction clip, a spring clip, and a snap fit connector. For example, FIG. 1C shows an exemplary trim 1300 where the coupling member 1330 is a friction clip.

In some implementations, the trim 1300 may be rotatably adjustable relative to the light module 1200 and the housing 1100a. For example, the twist and lock connector 1222 of the module housing 1210 may include a flat ridge that extends around a portion of the flange 1220 such that the tab 1340 of the trim 1300 may be supported at any position along the ridge. In this manner, the orientation of the trim 1300 may be adjusted to meet user preferences. For example, the trim 1300 may have a square-shaped flange 1320, thus rotating the trim 1300 may allow the recessed lighting system 1000a to adhere to a desired aesthetic in the environment or to match the orientation of another recessed lighting system 1000a in the environment. In another example, the trim 1300 may be configured for wall washing (e.g., lighting a flat wall), thus rotatable adjustment of the trim 1300 may allow a user to illuminate a particular portion of the wall or an object as desired. Once the desired orientation of the trim 1300 is set, the trim 1300 may be inserted and secured to the housing 1100a (along with the light module 1200 and the yoke 1400a) by the coupling member 1330 to maintain the orientation.

The trim 1300 may be formed from various metals and polymers including, but not limited to aluminum, steel, stainless steel, copper, polyvinyl chloride (PVC), acrylonitrile butadiene styrene (ABS), polycarbonate (PC), polyurethane (PU), polyethylene, polyethylene terephthalate, polypropylene, polystyrene, a Makrolon® polycarbonate, and a Therma-Tech™ thermally conductive compound.

### A Second Example of a Recessed Lighting System with a Yoke

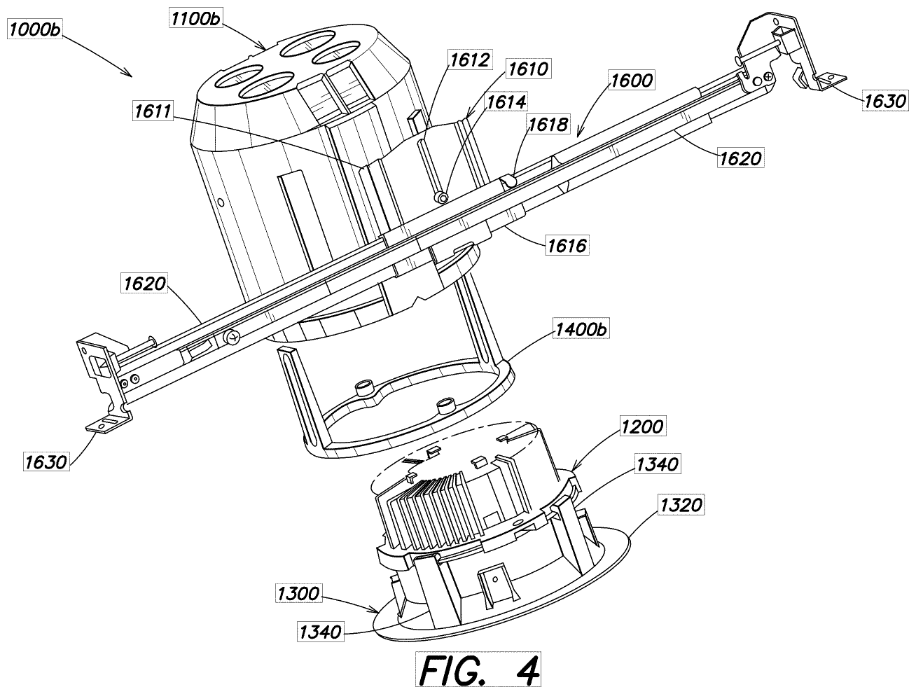

FIG. 4 shows another exemplary implementation of a recessed lighting system 1000b with a yoke 1400b. As before, the recessed lighting system 1000b may include a housing 1100b to cover and support the various components of the recessed lighting system 1000b. For instance, a yoke 1400b may be inserted into the cavity 1101 of the housing 1100b. The yoke 1400b may be used to facilitate the installation of a light module 1200. A trim 1300 may also be mounted to the light module 1200. The trim 1300 may further include a coupling member 1330 to secure the assembly of the yoke 1400b, the light module 1200, and the trim 1300 to the housing 1100b. FIG. 4 also shows a hanger bar assembly 1600 may be mounted to the sidewall 1102 of the housing 1100b for installation onto a building structure (e.g., a T-bar, a joist, a stud).

A method of installing the recessed lighting system 1000b depicted in FIG. 4 may be substantially similar to the method described above for the recessed lighting system 1000a. The various components of the recessed lighting system 1000b shown in FIG. 4, in particular the housing 1100b and the yoke 1400b, may include additional structural features to further improve the ease of installing the recessed lighting system 1000b.

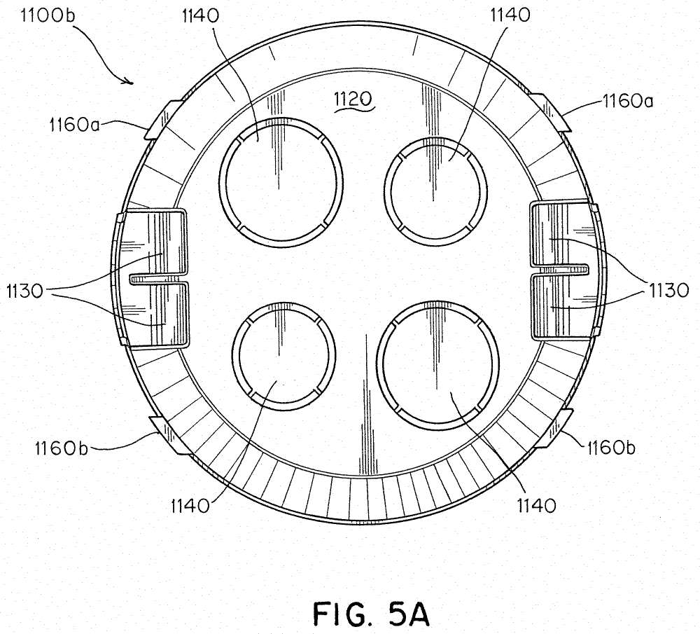

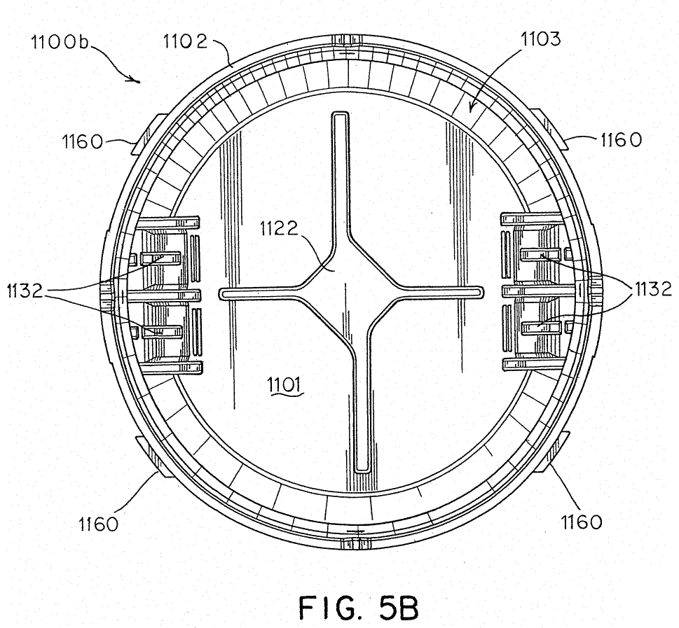

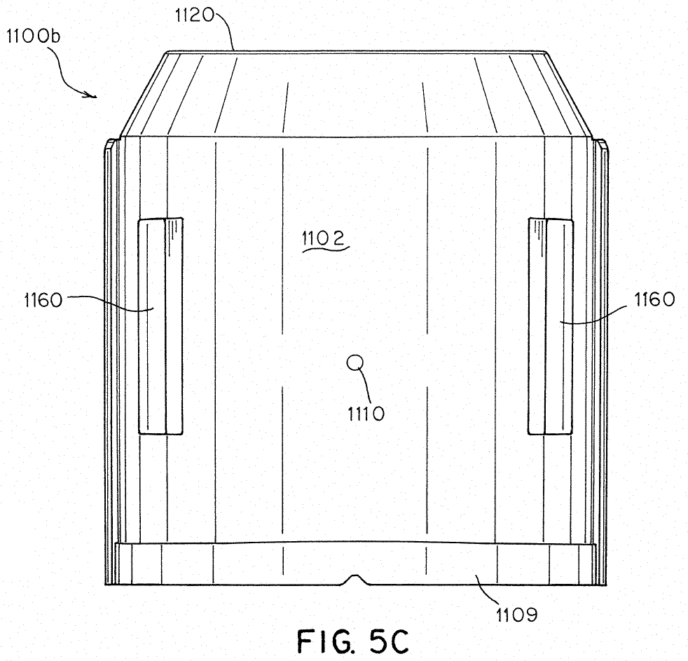

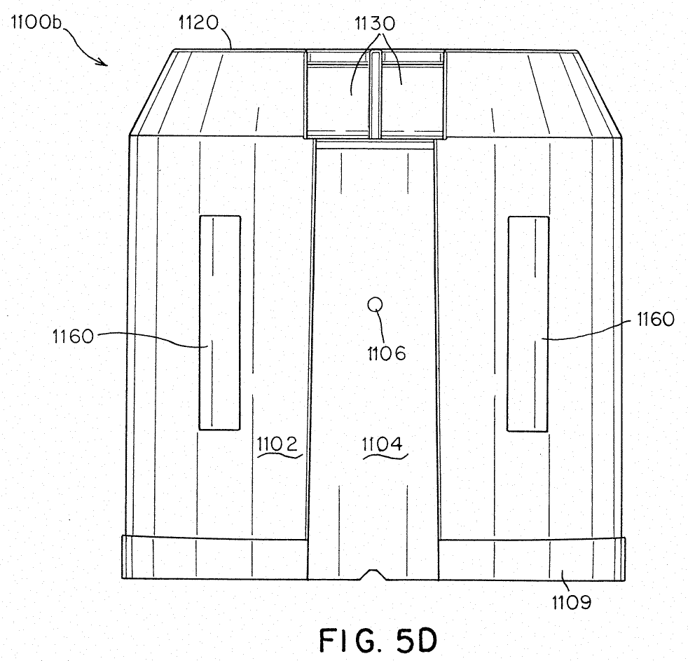

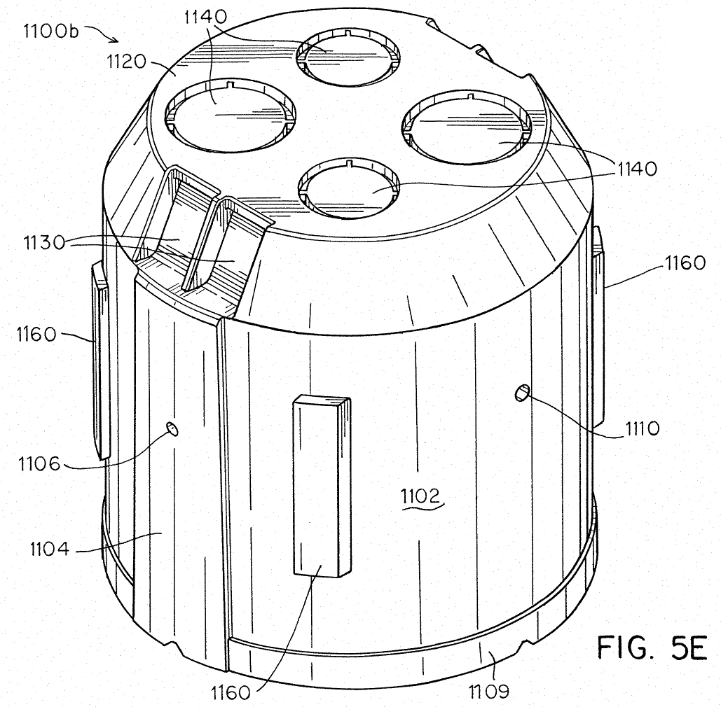

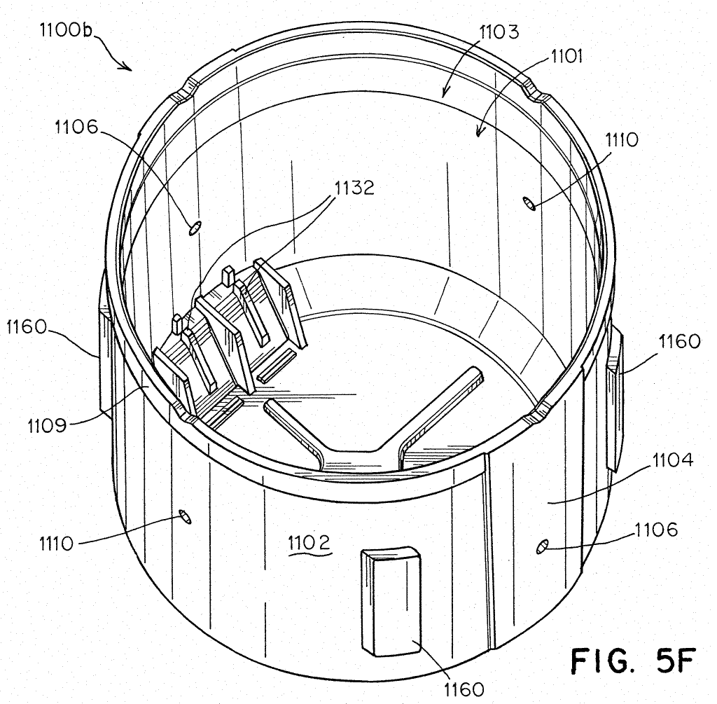

FIGS. 5A-5F show several views of the housing 1100b. The housing 1100b may generally include the same features as described above and below with respect to the other exemplary recessed lighting systems 1000. Additionally, the housing 1100b may also include a guide 1160 disposed on the sidewall of the housing 1100b. The guide 1160 may be used to facilitate the alignment and adjustment of a hanger bar holder 1610 in the hanger bar assembly 1600. For example, the guide 1160 may be a protrusion from the sidewall 1102 that abuts against a portion of the hanger bar holder 1610, thus constraining the motion of the hanger bar assembly 1600 along a preferred adjustment axis between the hanger bar holder 1610 and the housing 1100b. For example, the position of the hanger bar holder 1610 along the length of the sidewall 1102 may be adjustable. Thus, the guide 1160 may limit the lateral movement of the hanger bar holder 1610.

The housing 1100b may generally include one or more guides 1160. For example, FIGS. 5A-5F show the housing 1100b includes two pairs of guides 1160. Each pair of guides 1160a and 1160b may be used on opposing sides of the hanger bar holder 1610. The guide 1160 may generally span a portion of the sidewall 1102 (e.g., from the cover 1120 to the opening 1103). In some implementations, the guide 1160 may also be segmented to reduce the amount of material used during fabrication of the housing 1100b.

The housing 1100b may also include a reinforcing section 1122 on the cover 1120. As shown in FIGS. 5B and 5F, the reinforcing section 1122 may be a protrusion that extends into the cavity 1101 of the housing 1100b. The reinforcing section 1122 may be used to increase the structural rigidity of the housing 1100b, especially if one or more knockouts 1140 are removed during installation. As shown, the reinforcing section 1122 may partially surround the respective knockouts 1140 on the cover 1120 for this purpose.

The housing 1100b may also include knockouts 1140 and feedthrough tabs 1130 to facilitate entry of a wire/cable into the cavity 1101 of the housing 1100b as described above. The feedthrough tab 1130 on the housing 1100b may include mechanical stops 1132 as shown in FIGS. 5B and 5F. The mechanical stops 1132 may be used to limit how far the feedthrough tab 1130 is bent into the cavity 1101 of the housing 1100b. For example, the mechanical stops 1132 depicted in FIGS. 5B and 5F include a first portion on the feedthrough tab 1130 and a second portion at the base of the feedthrough tab 1130. As the feedthrough tab 1130 is bent into the cavity 1101, the first portion may physically contact the second portion thus preventing the feedthrough tab 1130 from being bent further inwards.

As before, the housing 1100b may be formed from various thermoplastic and thermosetting polymers including, but not limited to polyvinyl chloride (PVC), acrylonitrile butadiene styrene (ABS), polycarbonate (PC), polyurethane (PU), polyethylene, polyethylene terephthalate, polypropylene, and polystyrene. The housing 1100b may be fabricated using various manufacturing methods including, but not limited to injection molding, 3D printing, and blow molding.

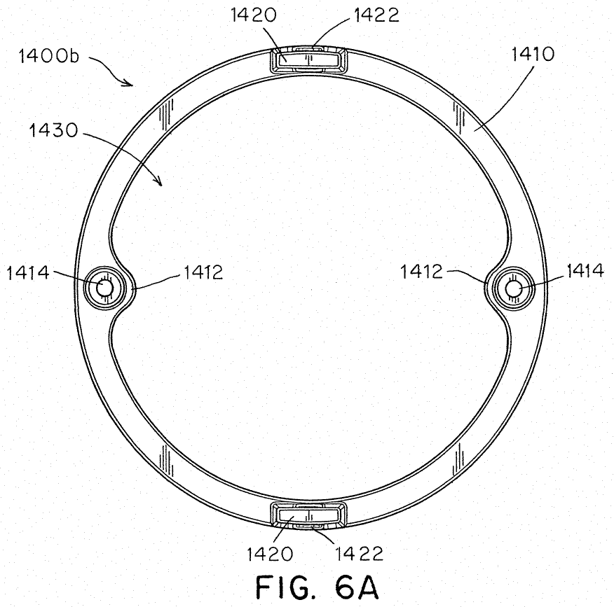

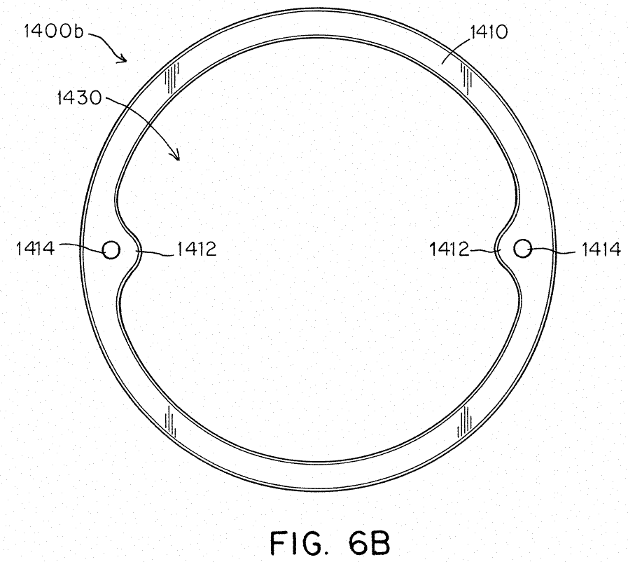

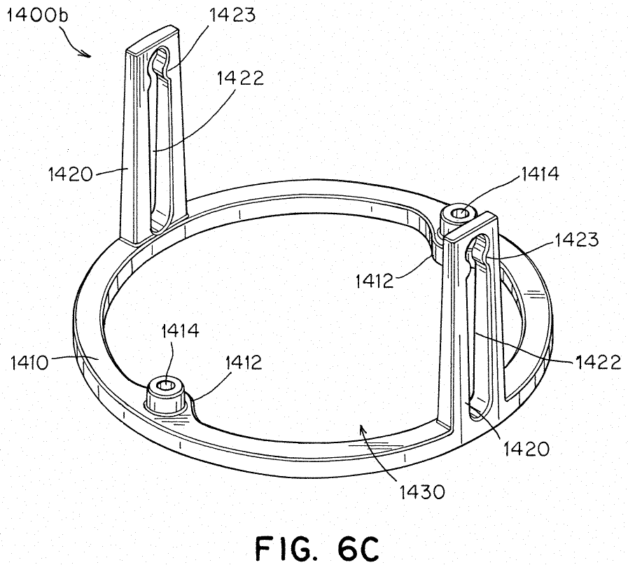

FIGS. 6A-6C show several views of the yoke 1400b. The yoke 1400b may include the same features as the yoke 1400a described above with respect to the other exemplary recessed lighting fixtures 1000. As shown in FIG. 6C, the openings 1414 of the yoke 1400b may include an extended section that protrudes from the frame 1410. This section may be used to increase the length of the opening 1414 in order to support a longer fastener. In some implementations, the opening 1414 may be threaded, thus the extended section may provide additional threads to engage with a fastener to better secure the light module 1200 to the yoke 1400b.

The arm 1420 of the yoke 1400b may include a slot 1422, as described above, to allow slidable adjustment of the yoke 1400b along an axis defined by the slot 1422. The slot 1422 may generally have a non-uniform width. For example, FIGS. 6A-6C show the slot 1422 having a choke 1423 (e.g., a section with a narrower width). If the width of the slot 1422 is based on the size of the coupling member used to couple and guide the yoke 1400b to the housing 1100b, the choke 1423 may be used to define a separate section of the slot 1422 where the yoke 1400b may be rigidly fixed to the coupling member, thus preventing the yoke 1400b from sliding relative to the housing 1100b. For the arm 1420 depicted in FIG. 6C, a user may pull the yoke 1400b out of the housing 1100b such that the coupling member is forced past the choke 1423, thus rigidly securing the yoke 1400b to the housing 1100b. This may allow a user to more easily mount the light module 1200 to the yoke 1400b by preventing the yoke 1400b from sliding along the slot 1422 as the user is coupling a fastener through the openings 1224 of the module housing 1210 and the openings 1414 of the yoke 1400b. It should be appreciated the arm 1420 may be sufficiently compliant to allow the coupling member to move past the choke 1423 without causing plastic deformation.

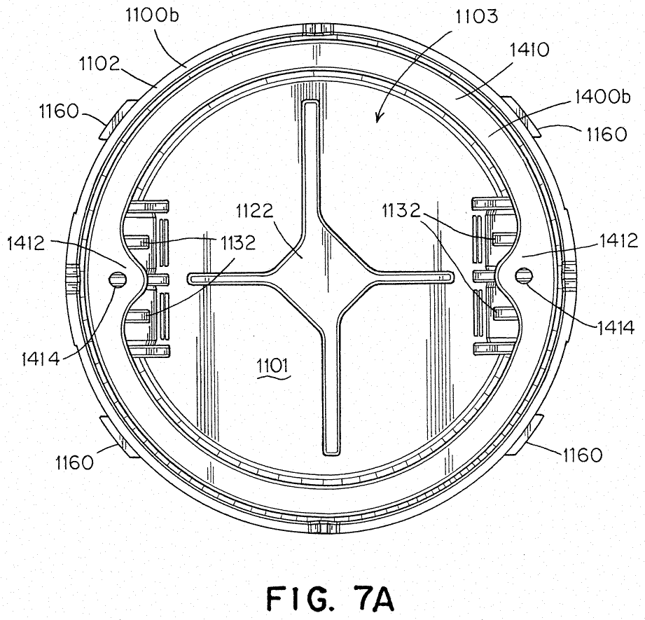

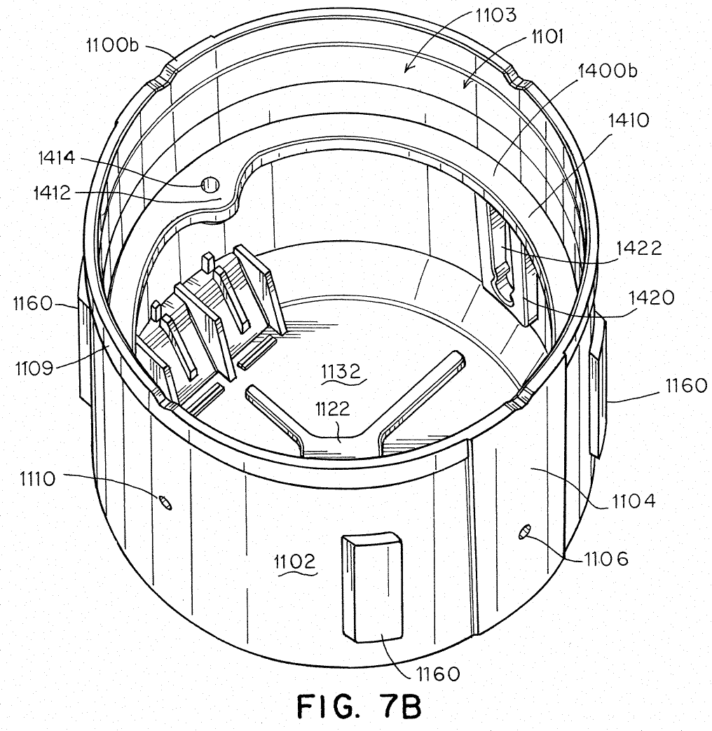

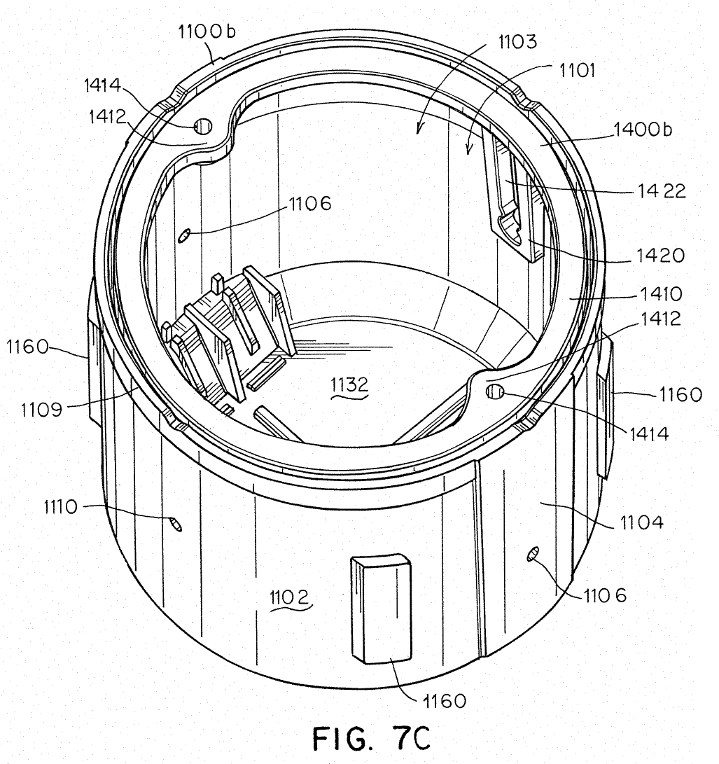

FIGS. 7A-7C show several views of the yoke 1400b disposed in the cavity 1101 of the housing 1100b. As before, the position and the length of the slot 1422 may define the positional limits of the yoke 1400b within the housing 1100b. FIG. 7B shows that at one limit, the arm 1420 of the yoke 1400b may be positioned proximate to the cover 1120 of the housing 1100b such that the light module 1200 is fully contained inside the cavity 1101 of the housing 1100b. FIG. 7C shows that at another limit, the frame 1410 of the yoke 1400b may abut the opening 1103 of the housing 1100b.

The hanger bar assembly 1600 shown in FIG. 4 may include a hanger bar holder 1610 to mount the hanger bar assembly 1600 to the housing 1100b, a hanger bar 1620 to adjust a position of the housing 1100b in the building structure, and a hanger bar head 1630 to mount the hanger bar assembly 1600 to the building structure (e.g., a T-bar, a joist, a stud). As shown, the hanger bar holder 1610 may include a frame 1611 that abuts against the sidewall 1102 of the housing 1100b. The frame 1611 may be shaped to fit between the guides 1160 on the sidewall housing 1100b thereby constraining and guiding the adjustment of the hanger bar holder 1610 along a desired adjustment axis while limiting unwanted motion along other axes.

The frame 1611 may include an adjustment feature that allows the position of the hanger bar assembly 1600 to be adjustable with respect to the housing 1100b. For example, FIG. 4 shows the adjustment feature as a slot 1612 where the hanger bar assembly 1600 is slidably adjustable along an axis defined by said slot 1612. The hanger bar holder 1610 may be coupled to the housing 1100b via a coupling member 1614 to the opening 1106 on the housing 1100b. The coupling member 1614 may be various coupling mechanisms including, but not limited to a screw fastener, a bolt fastener, a butterfly wing screw, and a thumbscrew.

The hanger bar holder 1610 may also include a track 1616 coupled to the frame 1611 to support and guide one or more hanger bars 1620. The track 1616 may constrain the hanger bars 1620 to move along an axis substantially orthogonal to the axis defined by the slot 1612, thus enabling the hanger bar assembly 1600 to be adjustable along multiple axes. In some implementations, the track 1616 may support two telescoping hanger bars 1620 in a manner that reduces unwanted lateral motion of the hanger bars 1620 along other axes orthogonal to the second axis. For example, the track 1616 may be shaped and/or tolerances such that the hanger bars 1620 are in contact with the track 1616, thus preventing the unwanted lateral motion (e.g., slop, backlash) between the hanger bars 1620 and the track 1616. The frame 1611 may also include a locking tab 1618 to secure the one or more hanger bars 1620 to a desired position during installation.

The hanger bar 1620 may be an elongated rail that is slidably adjustable along the track 1616 of the hanger bar holder 1610. In some implementations, the hanger bar 1620 may have a substantially uniform cross-sectional shape along the length of the hanger bar 1620. The cross-sectional shape may be configured to allow the hanger bar 1620 to be telescopically adjustable with respect to another hanger bar 1620. The cross-sectional shape of the hanger bar 1620 may also be configured to reduce unwanted lateral motion between adjoining hanger bars 1620. For example, the cross-sectional shape of the hanger bar 1620 may ensure the hanger bar 1620 maintains physical contact with another hanger bar 1620, thus limiting any unwanted backlash or slop between the hanger bars 1620. In some implementations, the pair of hanger bars 1620 supported by the hanger bar holder 1610 may be substantially identical to simplify manufacture.

The hanger bar head 1630 may be disposed at one end of the hanger bar 1620. The hanger bar head 1630 may include multiple features to facilitate attachment to various building structures including, but not limited to a T-bar, a joist, and a stud. The hanger bar head 1630 may couple to the building structure using various coupling mechanisms including, but not limited to a screw fastener, a bolt fastener, a snap fit connector, and an adhesive.

### A First Example of a Recessed Lighting System with a Partition Plate

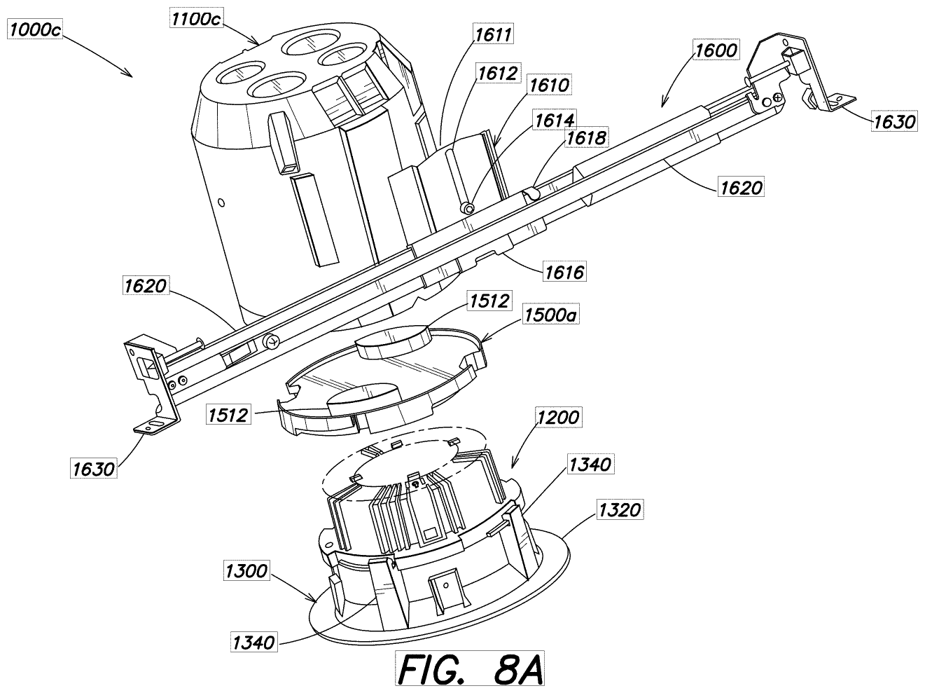

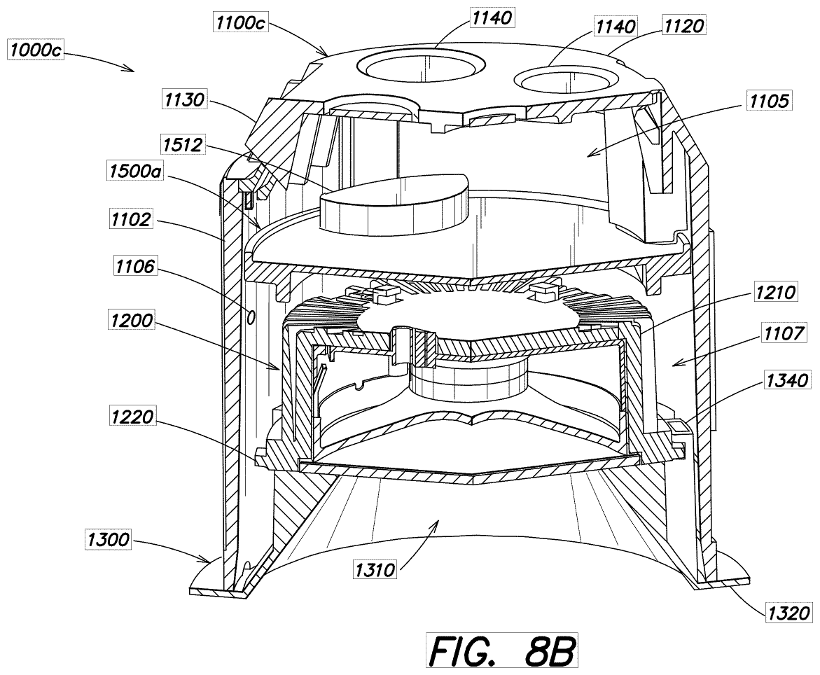

FIGS. 8A and 8B show several views of an exemplary recessed lighting system 1000c with a partition plate 1500a. As shown, the recessed lighting system 1000c may include a housing 1100c. The partition plate 1500a may be inserted into the cavity 1101 of the housing 1100c and secured to the sidewall 1102 to divide the cavity 1101 into a wiring compartment 1105 and a lighting compartment 1107. Once the partition plate 1500a is secured to the housing 1100c, a light module 1200 and a trim 1300 may be inserted into the lighting compartment 1107 and secured by a coupling member on the trim 1300. As before, a hanger bar assembly 1600 may be coupled to the sidewall 1102 of the housing 1100c to facilitate installation of the recessed lighting system 1000c onto a building structure.

The partition plate 1500a may be used to improve the ease of installing the light module 1200 and the trim 1300 by pushing the wires/cables disposed in the housing 1100c back, thus reducing their interference and/or obstruction of the housing 1100c when mounting the light module 1200 and the trim 1300. As shown in FIG. 8B, the partition plate 1500a and the light module 1200 may be positioned in the cavity 1101 of the housing 1100c such that a gap exists between the partition plate 1500a and the module housing 1210 of the light module 1200. In some implementations, the module housing 1210 or another portion of the light module 1200 may directly contact the partition plate 1500a. The partition plate 1500a may also be used to increase the structural rigidity of the housing 1100c by reinforcing the sidewall 1102. In this manner, the partition plate 1500a may also improve the thermal performance of the housing 1100c when the recessed lighting system 1000c is subjected to a fire.

Generally, a method of installing the recessed lighting system 1000c may include the following steps: (1) installing the housing 1100c into the building structure using the hanger bar assembly, (2) removing a knockout 1140 and/or opening a feedthrough tab 1130 to pass a wire or cable that supplies electrical power to the light module 1200 into the cavity 1101 of the housing 1100c, (3) configuring the wire/cable for connection (e.g., attaching a connector, connecting a ground wire to an electrical ground), (4) passing the wire/cable through a feedthrough openings 1514 and 1516 on the partition plate 1500a, (5) inserting and securing the partition plate 1500a to the cavity 1101 of the housing 1100c, (6) electrically coupling the light module 1200 to the wire/cable, (7) mounting the trim 1300 to the light module 1200, (8) inserting the light module 1200 and the trim 1300 into the lighting compartment 1107 of the housing 1100c. The trim 1300 may include a coupling mechanism, such as a friction spring clip, to secure the light module 1200 and the trim 1300 to the housing 1100c.

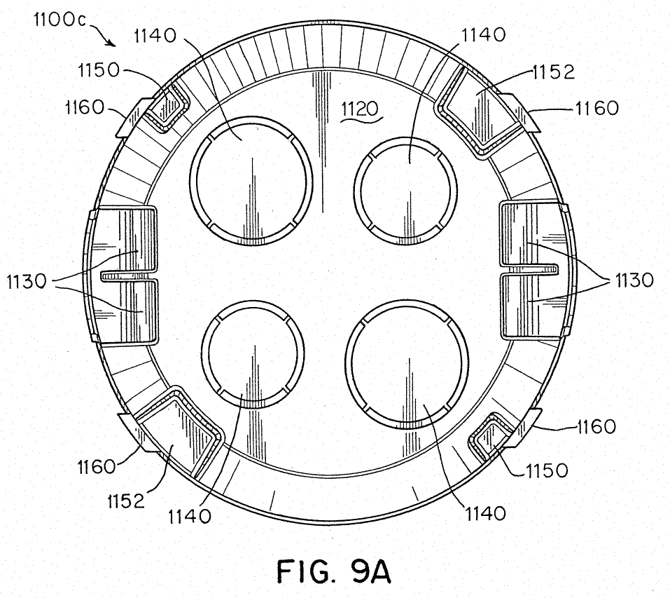

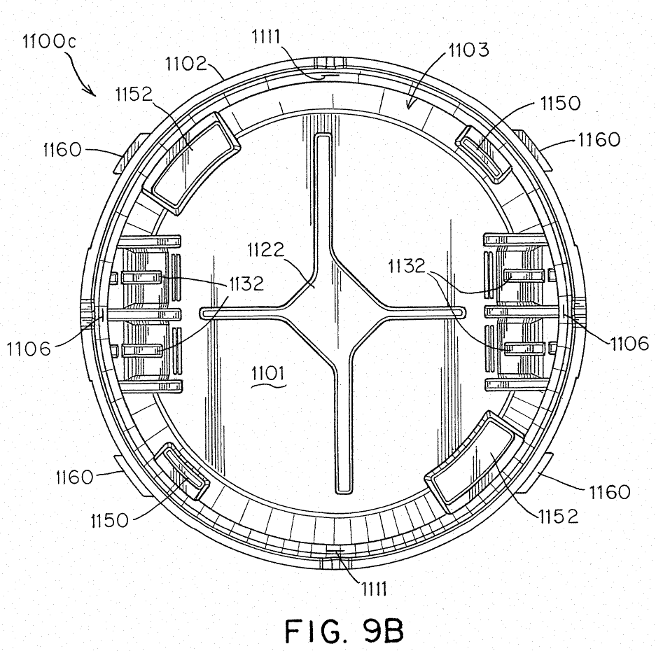

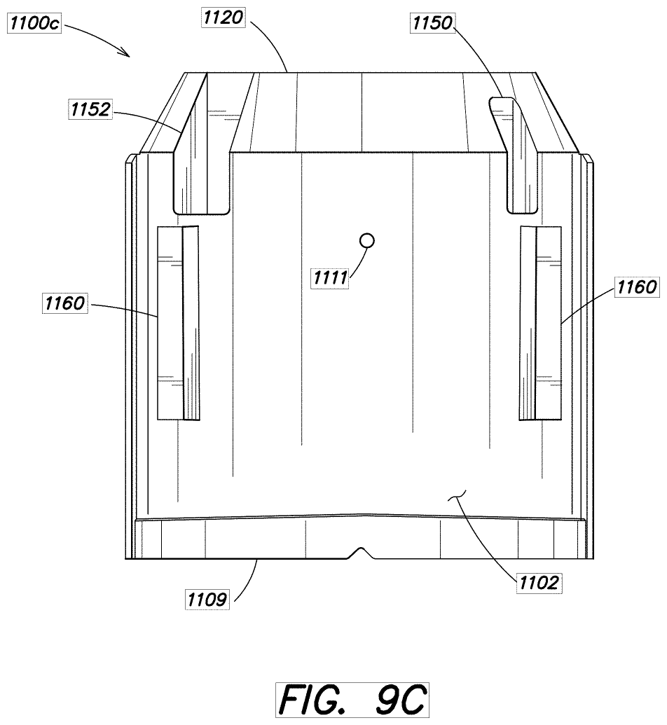

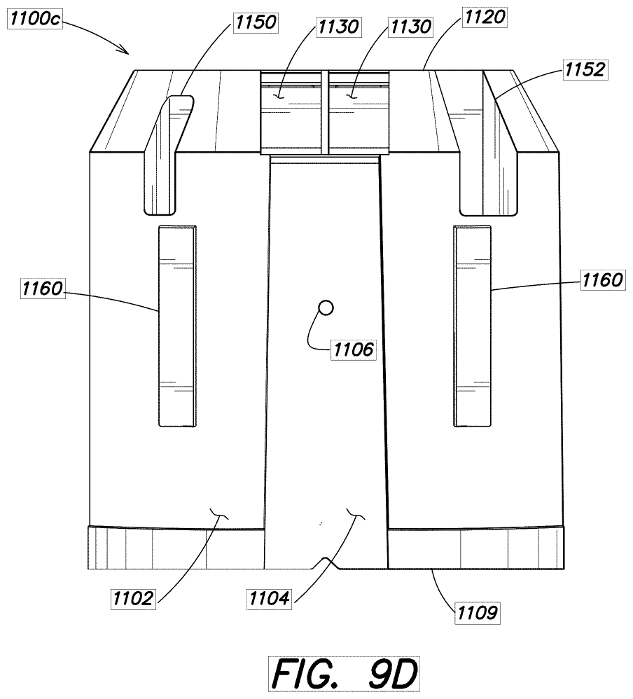

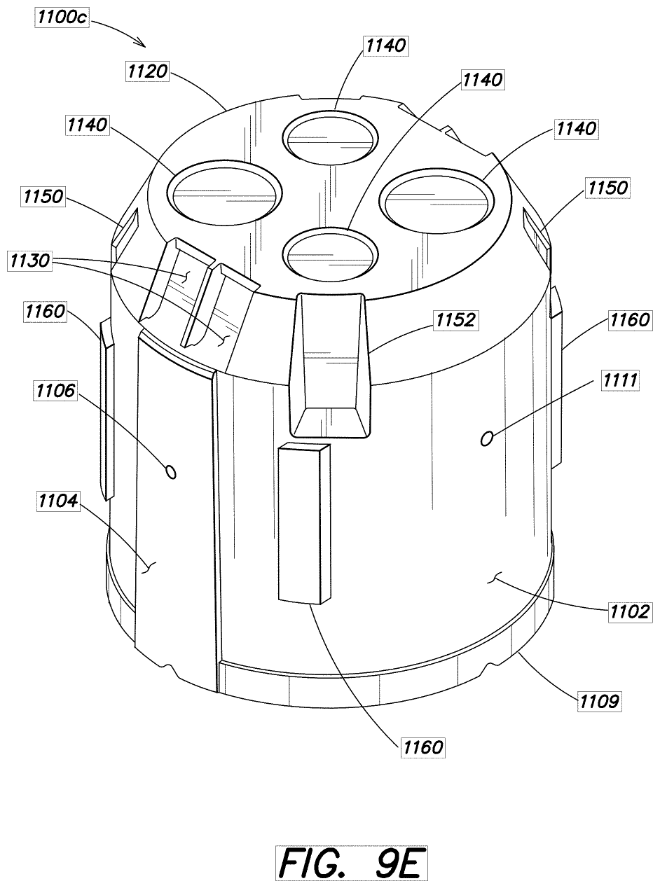

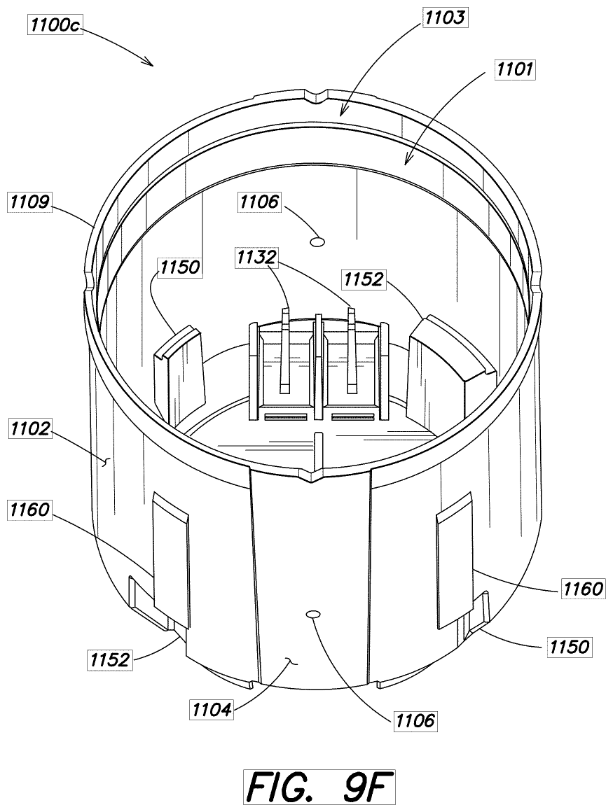

FIGS. 9A-9F show several views of the housing 1100c. The housing 1100c may include several of the same features described above and below with respect to the other exemplary recessed lighting fixtures 1000. Additionally, the housing 1100c may include support sections 1150 and 1152 to support the partition plate 1500a. As shown in FIGS. 9E and 9F, the support sections 1150 and 1152 may be integrated into the sidewall 1102 and/or the cover 1120 and may protrude into the cavity 1101 of the housing 1100c. The support sections 1150 and 1152 may have a thickness similar to the sidewall 1102 and/or the cover 1120, thus creating corresponding recesses on the exterior of the housing 1100c as shown in FIG. 9E. However, in some implementations, the support sections 1150 and 1152 may be formed with a larger thickness. For example, the support sections 1150 and 1152 may protrude into the cavity 1101 of the housing 1100c without forming a recess on the exterior surface of the sidewall 1102. Said in another way, the support sections 1150 and 1152 may be formed with sufficient thickness such that the support sections 1150 and 1152 are not observable on the exterior surface of the housing 1100c.

FIG. 9F shows the support sections 1150 and 1152 may each have a supporting surface that abuts a portion of the partition plate 1500a. Thus, the shape and dimensions of the support sections 1150 and 1152 may determine where the partition plate 1500a is positioned within the cavity 1101 of the housing 1100c. This, in turn, may dictate the dimensions and the volume of the wiring compartment 1105 and the lighting compartment 1107. In some implementations, the support sections 1150 and 1152 may be dimensioned such that the volume of the wiring compartment 1105 is similar to previous junction boxes (e.g., between about 15 cubic inches to about 30 cubic inches). The volume of the wiring compartment 1105 may be dimensioned to support multiple wires/cables of varying size as described above. For example, the wiring compartment 1105 may house at least 8 wires/cables that each have a gauge of at least about 12.

Additionally, the supporting surface may include a groove that matches a ridge 1513 on the partition plate 1500a. The groove may be used to align and/or register the partition plate 1500a to the support sections 1150 and 1152 during installation. In some implementations, the partition plate 1500a may be coupled to the housing 1100c via a twist and lock connector, thus the grooves may be also be used to guide a twisting motion of the partition plate 1500a. To secure the partition plate 1500a to the housing 1100c via the twist and lock mechanism, the housing 1100c may also include an opening 1111 to receive a peg 1112 to engage with and secure the partition plate 1500a to the housing 1100c. It should be appreciated the peg 1112 may be other coupling members including, but not limited to a screw fastener, a bolt fastener, a dowel, and a rod.

It should be appreciated the housing 1100c shown in FIGS. 9A-9F is configured for use with a partition plate 1500a and thus does not include structural features for the yoke 1400 (e.g., yokes 1400a and 1400b). However, in some implementations, the housing 1100c may include features to facilitate the installation of both the partition plate 1500a and/or the yoke 1400 to provide greater flexibility in configuring the recessed lighting system 1000c for different use cases depending on whether the yoke 1400 or the partition plate 1500a is more preferable. In this manner, a single design for the housing 1100c may be manufactured as opposed to two separate designs. In some implementations, the housing 1100c may be configured to support both the partition plate 1500a and the yoke 1400 simultaneously.

As before, the housing 1100c may be formed from various thermoplastic and thermosetting polymers including, but not limited to polyvinyl chloride (PVC), acrylonitrile butadiene styrene (ABS), polycarbonate (PC), polyurethane (PU), polyethylene, polyethylene terephthalate, polypropylene, and polystyrene. The housing 1100c may be fabricated using various manufacturing methods including, but not limited to injection molding, 3D printing, and blow molding.

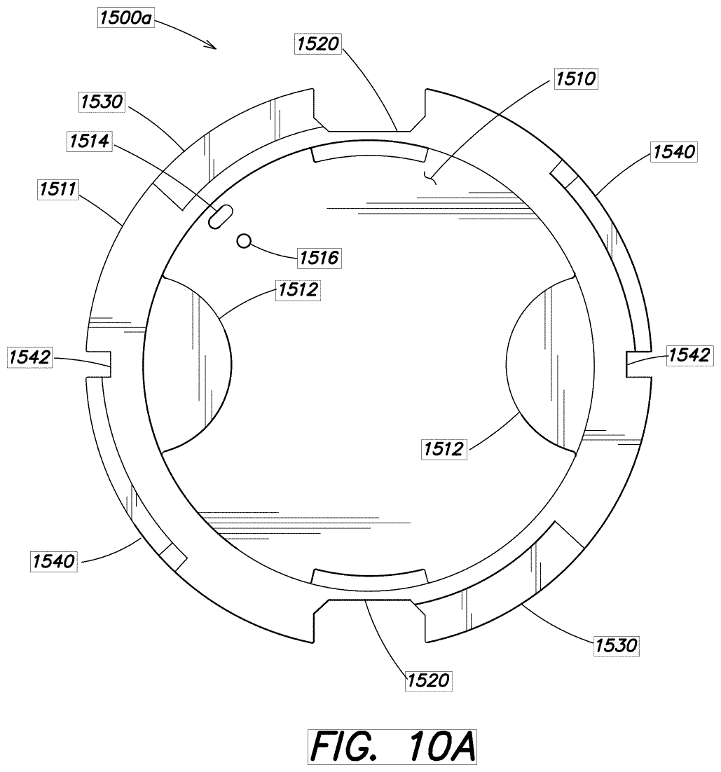

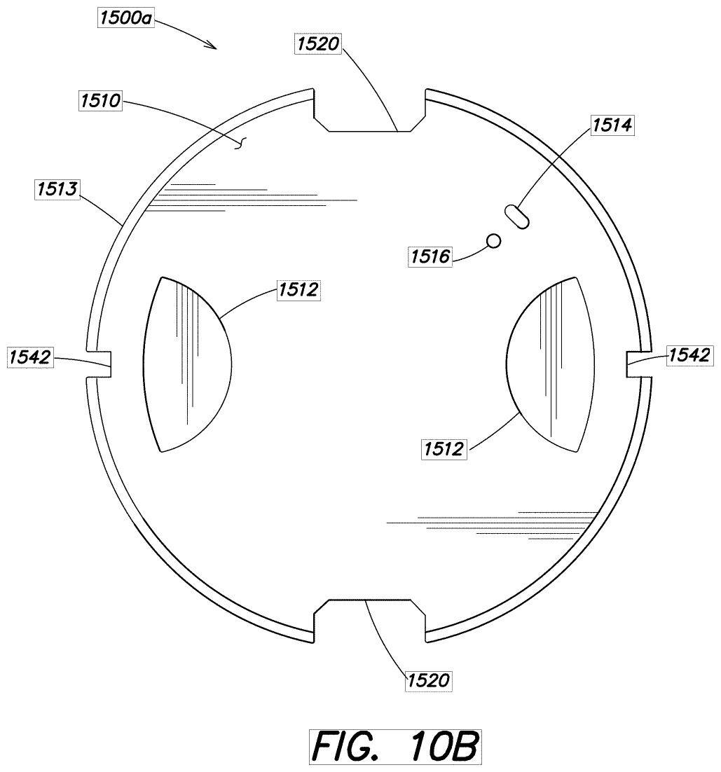

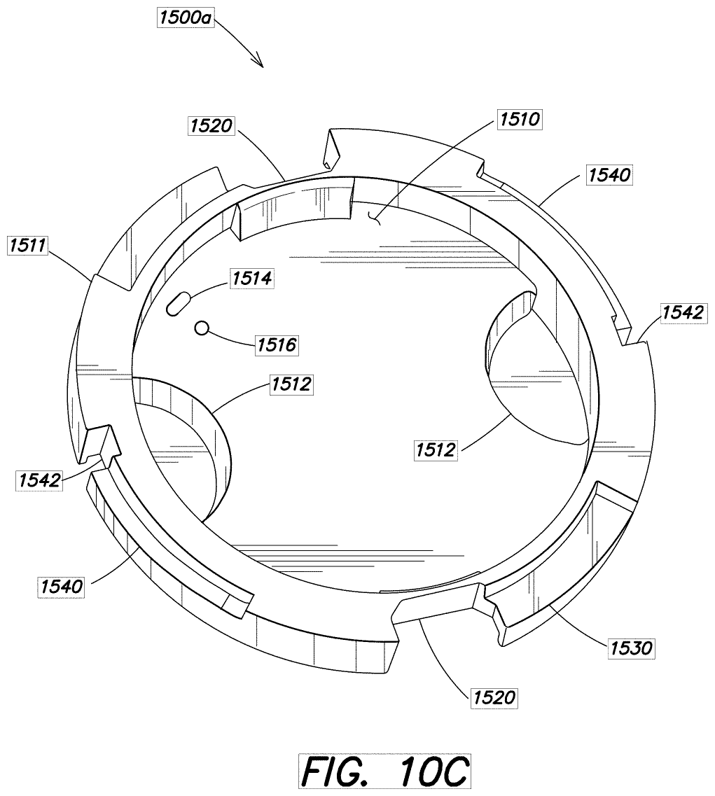

FIGS. 10A-10C show several views of the partition plate 1500a. As shown the partition plate 1500a includes a base 1510 to support the various features of the partition plate 1500a. The base 1510 may include a flange 1511 along the periphery of the base 1510. The flange 1511 may be used, in part, to incorporate a coupling mechanism to couple the partition plate 1500a to the housing 1100c and to increase the structural rigidity of the partition plate 1500a. The partition plate 1500a may generally have various cross-sectional shapes (the cross-section being defined along a plane parallel to the opening 1103 of the housing 1100c) including, but not limited to a circle, an ellipse, a regular polygon, and an irregular polygon. In some implementations, the shape of the partition plate 1500a may be based on the shape of the cavity 1101 of the housing 1100c such that the partition plate 1500a may substantially separate the wiring compartment 1105 from the lighting compartment 1107.

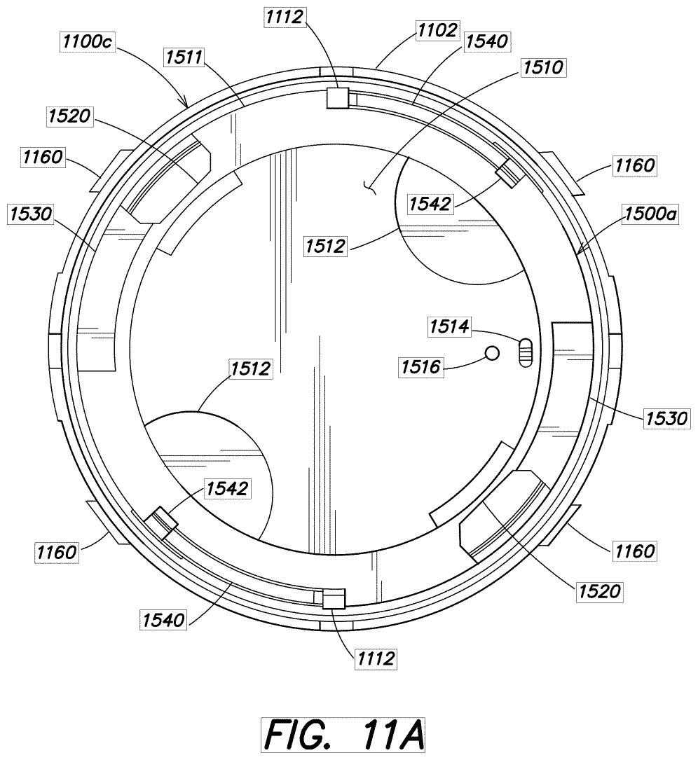

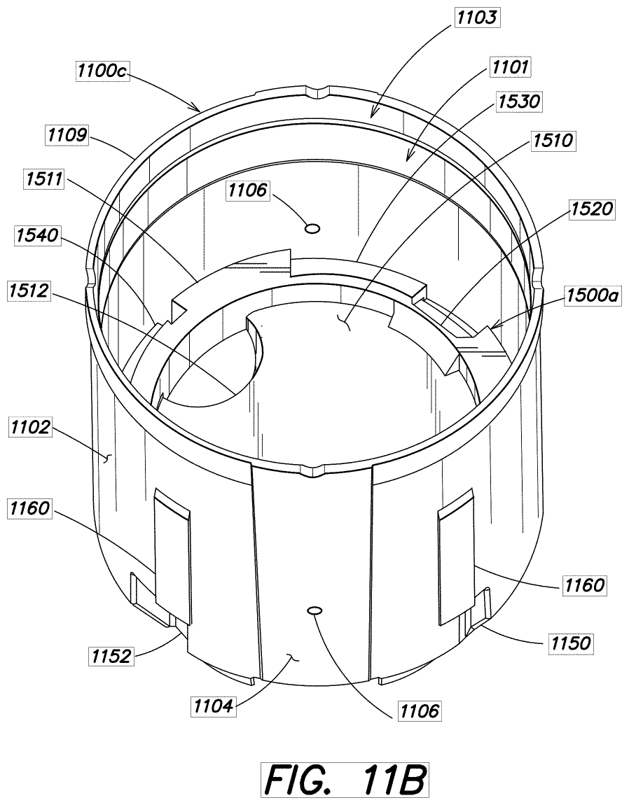

Various types of coupling mechanisms may be used including, but not limited to a twist and lock connector, a snap fit connector, a friction clip, and a spring clip. FIGS. 10A-10C show the partition plate 1500a as having a twist and lock connector 1540 and a recessed connector 1530 on the flange 1511 to abut against the support sections 1150 and 1152 of the housing 1100c. The twist and lock connector 1540 may include a notch 1542 to allow the peg 1112 on the housing 1100c to pass through said notch 1542 when the partition plate 1500a is inserted into the cavity 1101 of the housing 1100c. As the partition plate 1500a is rotated, the peg 1112 may engage with the twist and lock connector 1540 as shown in FIG. 11A. The recessed connector 1530 may include a notch 1520 to allow the partition plate 1500a to pass by the coupling member 1614 used to couple the hanger bar assembly 1600 to the housing 1100c (e.g., a thumbscrew, a butterfly wing screw) when inserted into the cavity 1101 of the housing 1100c. Additionally, the partition plate 1500a may include the ridge 1513 protruding from the bottom of the partition plate 1500a along the periphery to align with the groove on the support sections 1150 and 1152 of the housing 1100c.

The flange 1511 may be dimensioned and shaped to increase the structural rigidity of the partition plate 1500a. For example, the flange 1511 may be dimensioned to ensure the partition plate 1500a does not have portions that are excessively thin, such as near the notches 1520 and 1542 and/or the connectors 1530 and 1540. The base 1510 may also include features 1512 to structurally reinforce the partition plate 1500a by increasing the structural rigidity, such as a gusset. In some implementations, the structural features 1512 may be placed proximate to the depressions formed by the twist and lock connector 1540 to increase the structural rigidity. As shown in FIGS. 10B and 10C, the features 1512 may be a protrusion on the bottom side of the partition plate 1500a corresponding to a recess formed on the top side of the base 1510.

The partition plate 1500a may also include feedthroughs for a wire/cable to pass from the wiring compartment 1105 into the lighting compartment 1107 to electrically connect the light module 1200 to an electrical power source. As shown in FIGS. 10A-10C, the partition plate 1500a may include feedthroughs 1514 and 1516 for AC/DC wires/cables and a ground wire, respectively, disposed on the base 1510. The feedthroughs 1514 and 1516 may be dimensioned according to the size of the respective wire/cable used by the light module 1200. The feedthroughs 1514 and 1516 may also be positioned on the partition plate 1500a to improve the ease of routing the wires/cables from the wiring compartment 1105 to the lighting compartment 1107, which may depend on the location of the feedthrough tab 1130 or knockout 1140 used to insert the wire/cable and/or the position of an electrical connector on the light module 1200.

The partition plate 1500a may be formed from various metals, thermoplastic polymers, and thermosetting polymers including, but not limited to aluminum, steel, stainless steel, polyvinyl chloride (PVC), acrylonitrile butadiene styrene (ABS), polycarbonate (PC), and polyurethane (PU), polyethylene, polyethylene terephthalate, polypropylene, polystyrene, a Makrolon® polycarbonate, and a Therma-Tech™ thermally conductive compound. The partition plate 1500a may be fabricated using various manufacturing methods including, but not limited to injection molding, 3D printing, blow molding, casting, and machining.

FIGS. 11A and 11B show several views of the partition plate 1500a disposed in the cavity 1101 of the housing 1100c. As shown in FIG. 11A, the partition plate 1500a may be secured to the housing 1100c via a peg 1112 that engages with the twist and lock connector 1540. Furthermore, the partition plate 1500a may be shaped and dimensioned to match the cross-sectional shape of the cavity 1101 of the housing 1100c such that the flange 1511 of the partition plate 1500a is proximate to, or, in some instances, contacts the sidewall 1102 of the housing 1100c.

### A Second Example of a Recessed Lighting System with a Partition Plate

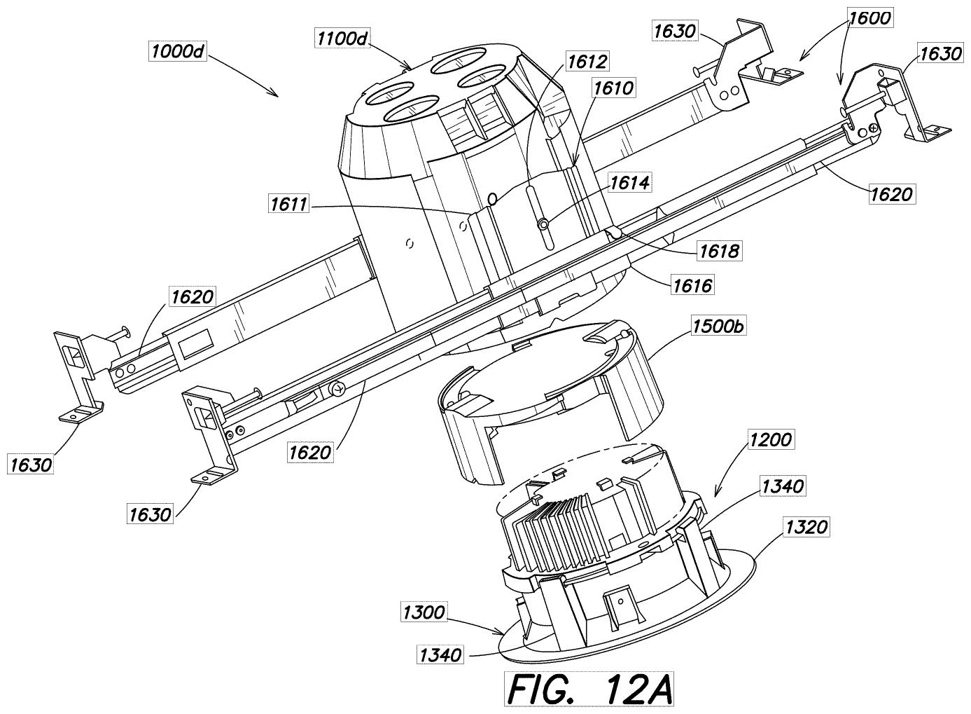

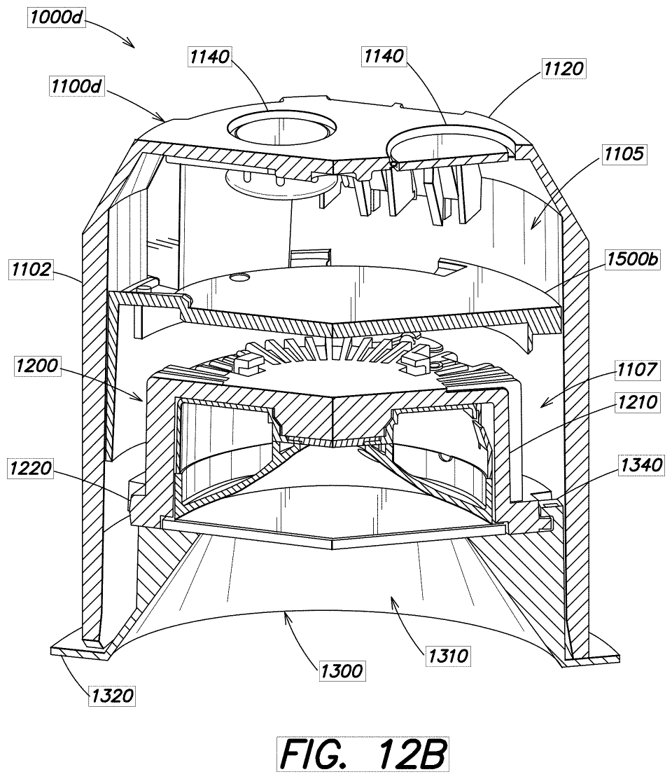

FIGS. 12A and 12B show several views of a second exemplary implementation of a recessed lighting system 1000d with a partition plate 1500b. As before, the recessed lighting system 1000d may include a housing 1100d to cover and support the various components of the recessed lighting system 1000d. A partition plate 1500b may be inserted into the cavity 1101 of the housing 1100d to push back against wires/cables in the housing 1100d and to define a wiring compartment 1105 and a lighting compartment 1107. A light module 1200 and a trim 1300 may be inserted into the lighting compartment 1107. The trim 1300 may further include a coupling member 1330 to secure the assembly of the light module 1200 and the trim 1300 to the housing 1100d. FIG. 12A also shows a hanger bar assembly 1600 may be mounted to the sidewall 1102 of the housing 1100d for installation onto a building structure (e.g., a T-bar, a joist, a stud). A method of installing the recessed lighting system 1000d depicted in FIG. 12A may be substantially similar to the method described above for the recessed lighting system 1000c.

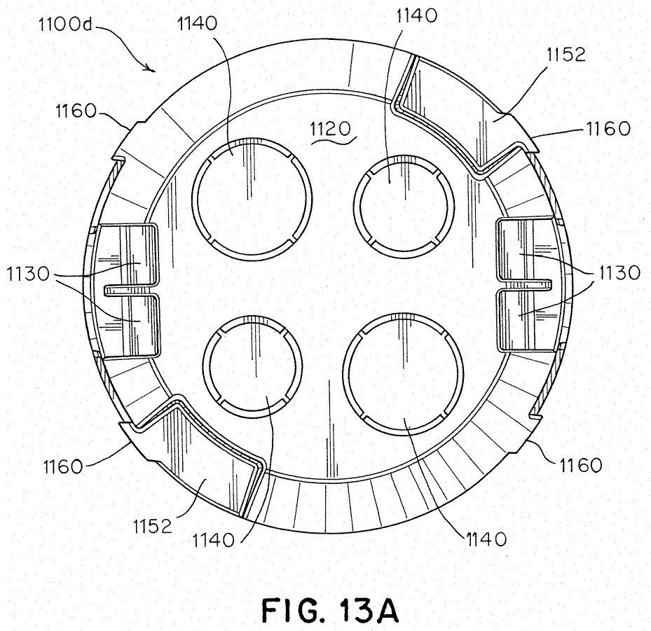

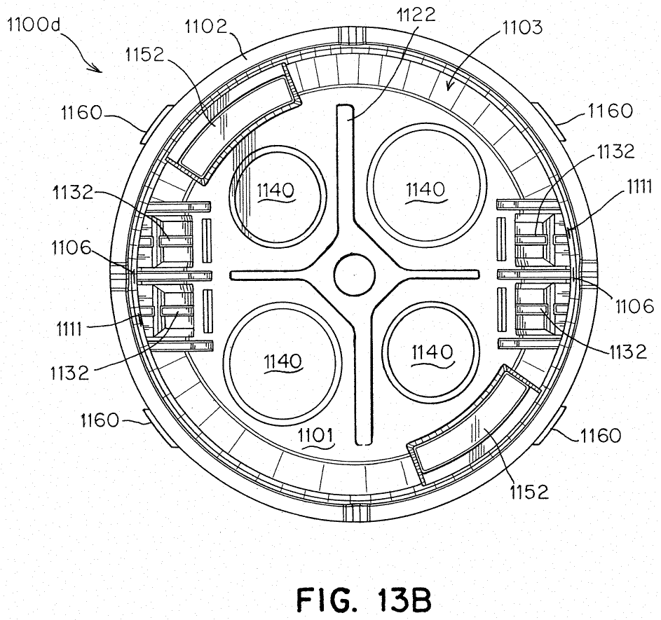

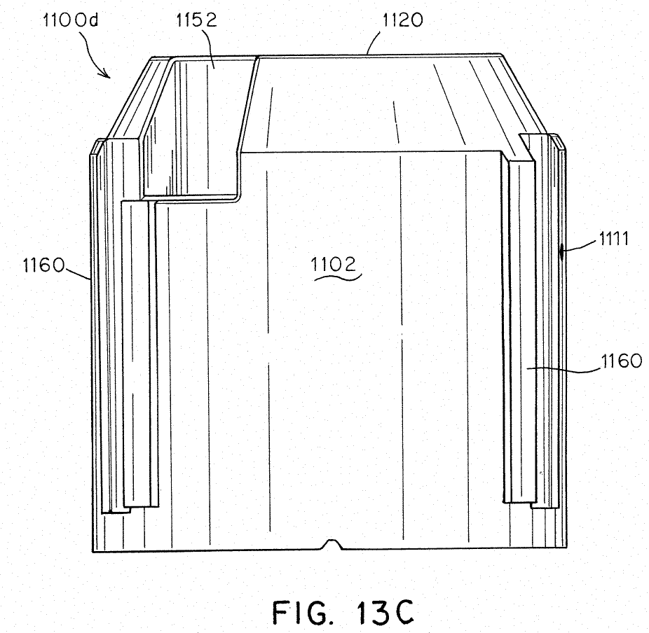

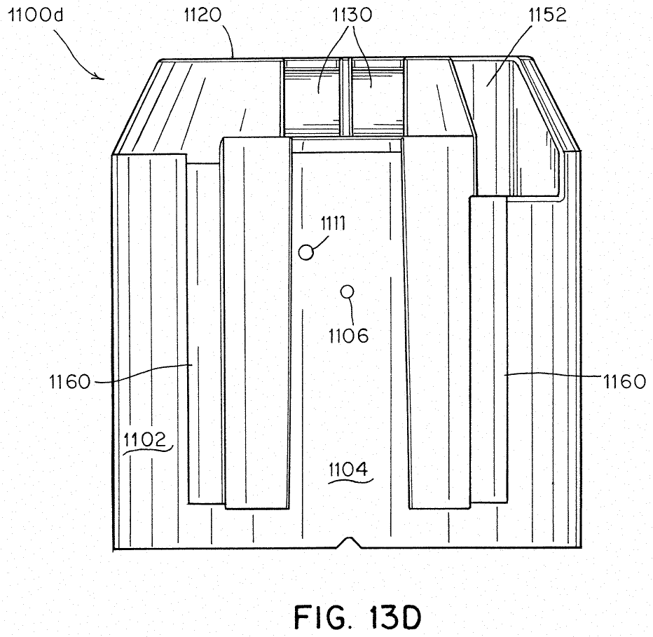

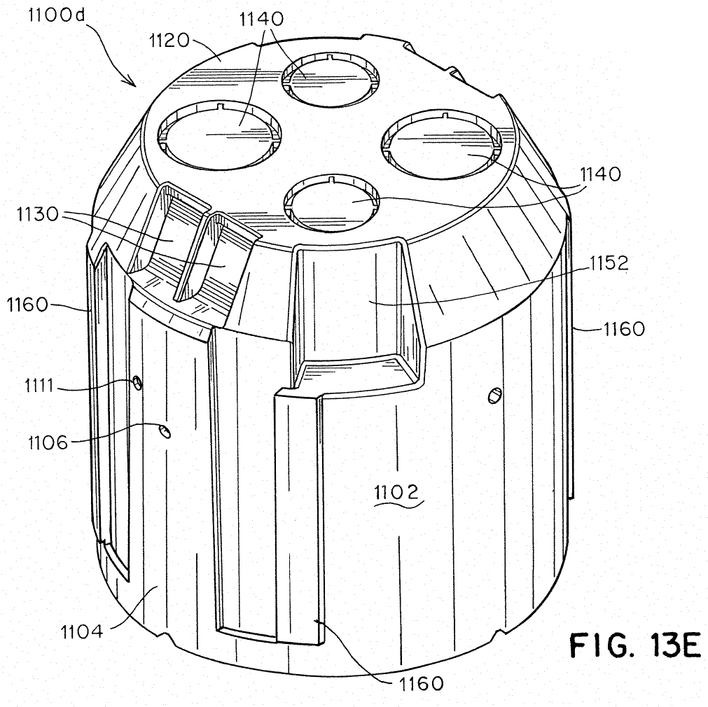

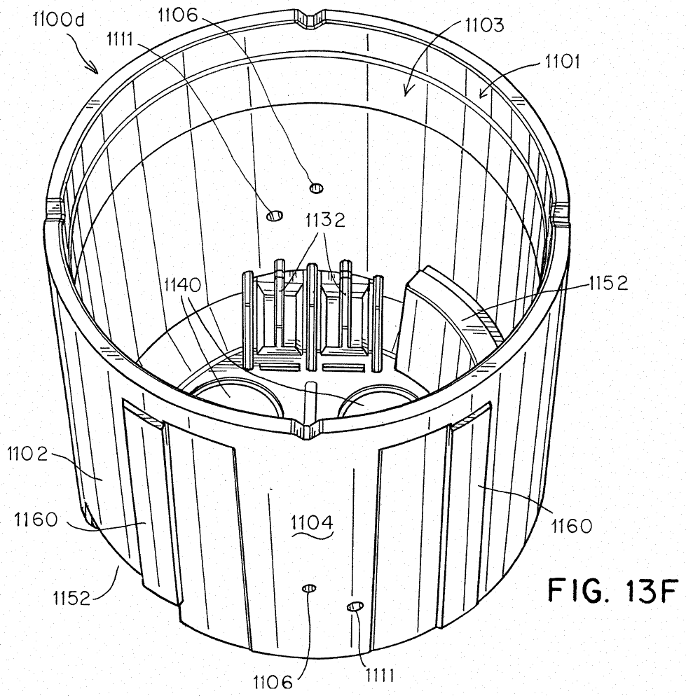

FIGS. 13A-13F show several views of the housing 1100d. The housing 1100d may include several of the same features described above and below with respect to the other exemplary recessed lighting fixtures 1000. For the housing 1100d depicted in FIGS. 13A-13F, the guides 1160 may be extended to cover a larger portion between the opening 1103 and the cover 1120 in order to provide additional alignment to the hanger bar assembly 1600 during assembly. Additionally, the housing 1100d may only have support section 1152 (the support sections 1150 are no longer included) to simplify manufacture of the housing 1100d. The location of the opening 1111 used to receive the peg 1112 that engages with the partition plate 1500b may correspondingly be relocated based on the position of the support section 1152 on the housing 1100d.

As before, the housing 1100d may be formed from various thermoplastic and thermosetting polymers including, but not limited to polyvinyl chloride (PVC), acrylonitrile butadiene styrene (ABS), polycarbonate (PC), polyurethane (PU), polyethylene, polyethylene terephthalate, polypropylene, and polystyrene. The housing 1100d may be fabricated using various manufacturing methods including, but not limited to injection molding, 3D printing, and blow molding.

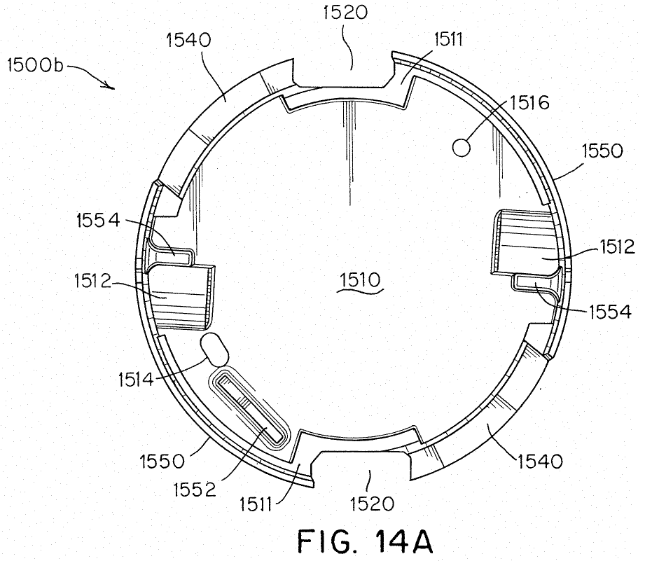

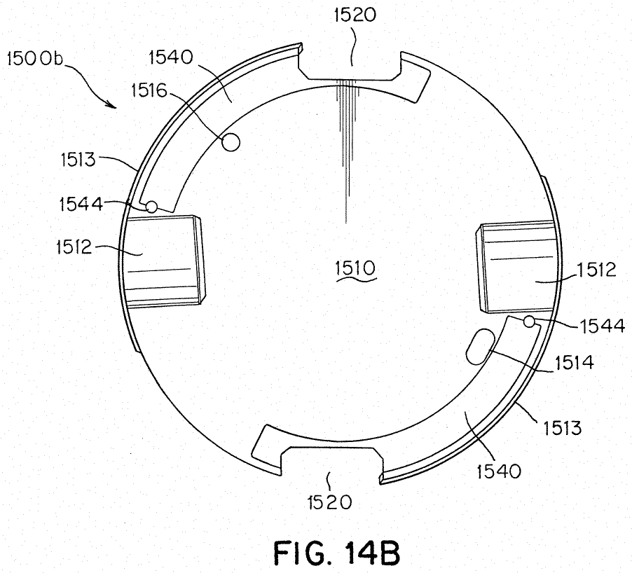

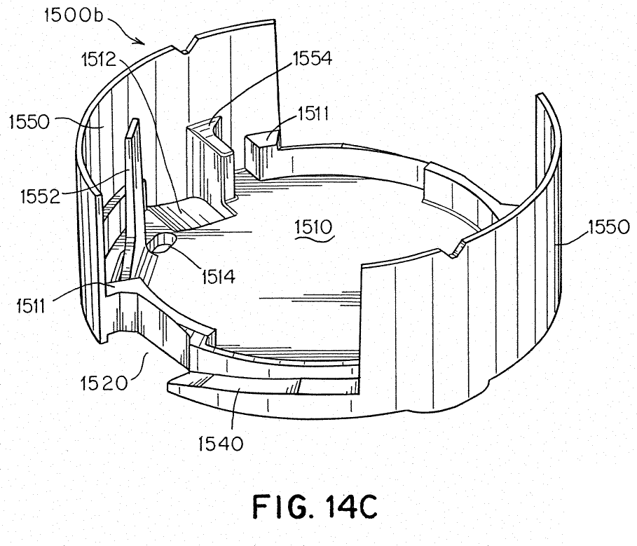

FIGS. 14A-14C show several views of the partition plate 1500b. The partition plate 1500b may include several of the same features as described above and below with respect to the other exemplary recessed lighting fixtures 1000. The partition plate 1500b shown in FIGS. 14A-14C may further include additional structural features to improve ease of installation and/or the structural properties of the partition plate 1500b. For example, FIG. 14C shows the partition plate 1500b includes walls 1550 on the flange 1511, which may be used, in part, to guide the partition plate 1500b into the cavity 1101 of the housing 1100d by reducing the amount of side to side movement and/or rotation of the partition plate 1500b as the partition plate 1500b is being inserted into the housing 1100d. The walls 1550 may also increase the structural rigidity of the partition plate 1500b and the housing 1100d once the partition plate 1500b is installed.

The partition plate 1500b may also include a structural feature 1554 on top of the base 1510 that abuts the feature 1512 disposed on the bottom of the partition plate 1500b. The structural feature 1554 may be used to increase the structural rigidity near the structural feature 1512. Additionally, the structural feature 1554 may provide a surface against which a user may press against when rotating the partition plate 1500b to engage the twist and lock connector 1540.

FIGS. 14A and 14C also show the partition plate 1500b may include a cable restraint 1552 disposed on the top of the base 1510. The cable restraint 1552 may be used to secure a portion of a wire/cable (e.g., AC/DC wire/cable) inserted through the feedthrough 1514 such that the wire/cable is kept to the side when the light module 1200 is inserted into the housing 1100d. For example, the cable restraint 1552 may also be positioned proximate to the flange 1511 such that a portion of the wire/cable or a connector at the end of the wire/cable is constrained by a combination of the cable restraint 1552 and the flange 1511. In this manner, the connector at the end of the wire/cable does not interfere with the light module 1200 as the light module 1200 is pushed into the cavity 1101 of the housing 1100d. In some implementations, a wire/cable with excess length may be wrapped around the cable restraint 1552.

The partition plate 1500b of FIGS. 14A-14C also removes the recessed connector 1530 and includes only the twist and lock connector 1540 thus simplifying manufacture of the partition plate 1500b. The notch 1520 may thus allow the partition plate 1500b to pass through the peg 1112 and the coupling member 1614 for the hanger bar assembly 1600. The partition plate 1500b may also include a mechanical stop 1544 at an end of the twist and lock connector 1540. The mechanical stop 1544 may prevent the partition plate 1500b from rotating beyond a desired position when installed into the cavity 1101 of the housing 1100d. Additionally, the inclusion of the mechanical stop 1544 may enable the twist and lock connector 1540 to have a shallower depth on the flange 1511, thus increasing the structural rigidity of the partition plate 1500b.

As before, the partition plate 1500b may be formed from various metals, thermoplastic polymers, and thermosetting polymers including, but not limited to aluminum, steel, stainless steel, polyvinyl chloride (PVC), acrylonitrile butadiene styrene (ABS), polycarbonate (PC), and polyurethane (PU), polyethylene, polyethylene terephthalate, polypropylene, polystyrene, a Makrolon® polycarbonate, and a Therma-Tech™ thermally conductive compound. The partition plate 1500b may be fabricated using various manufacturing methods including, but not limited to injection molding, 3D printing, blow molding, casting, and machining.

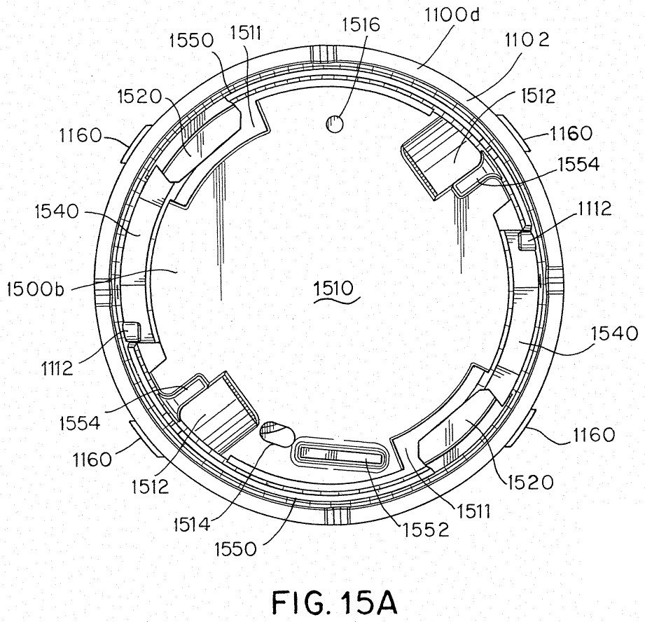

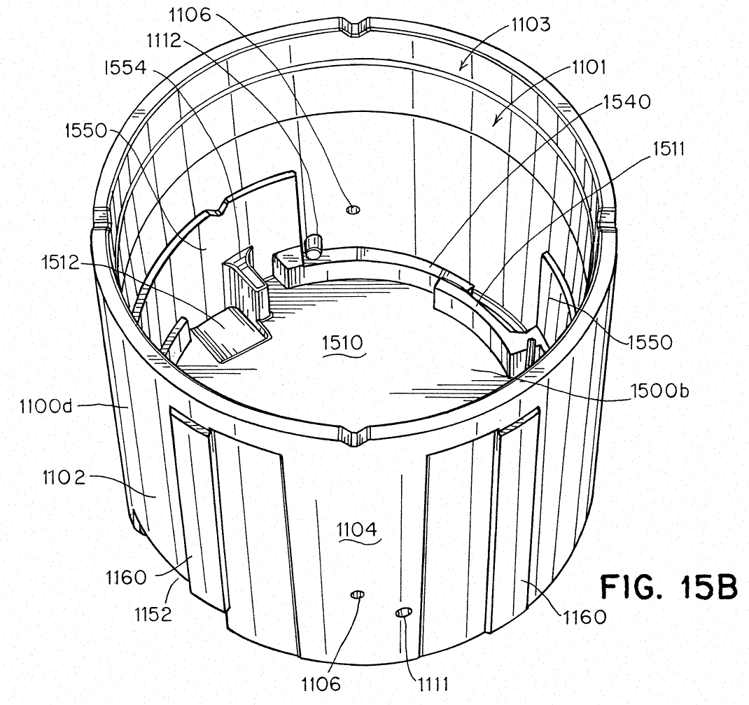

FIGS. 15A and 15B show several views of the partition plate 1500b disposed in the cavity 1101 of the housing 1100d. As shown, the walls 1550 on the partition plate 1500b may be proximate to or, in some instances, contact the sidewall 1102 of the housing 1100d. As before, the peg 1112 on the housing 1100d may engage the twist and lock connector 1540 thus securing the partition plate 1500b to the housing 1100d.

### A Third Example of a Recessed Lighting System with a Partition Plate

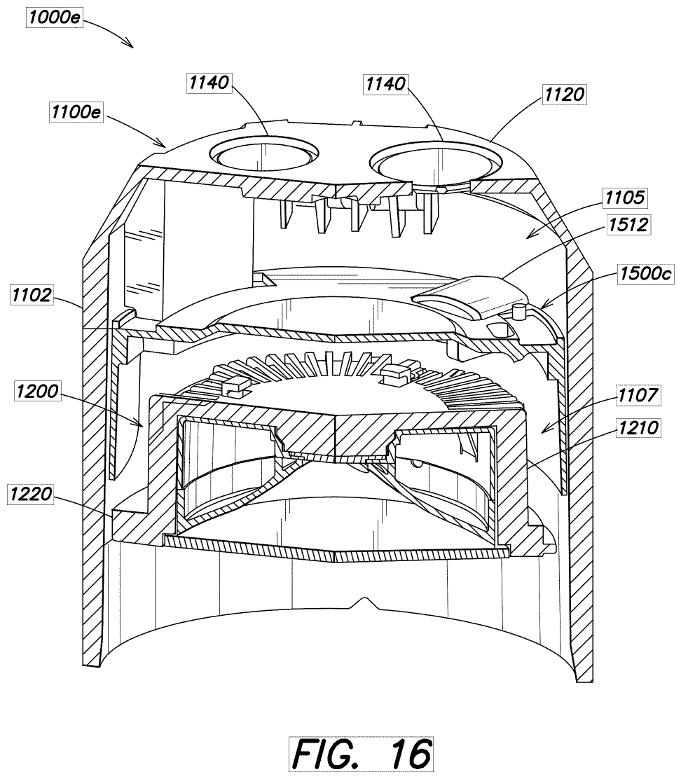

FIG. 16 shows a third exemplary implementation of a recessed lighting system 1000e with a partition plate 1500c. In this implementation, the housing 1100e is the same as the housing 1100d shown in FIGS. 13A-13F. As before, a partition plate 1500c may be inserted into the cavity 1101 of the housing 1100e to push back against wires/cables in the housing 1100e and to define a wiring compartment 1105 and a lighting compartment 1107. A light module 1200 and a trim 1300 may be inserted into the lighting compartment 1107. The trim 1300 may further include a coupling member 1330 to secure the assembly of the light module 1200 and the trim 1300 to the housing 1100e. A hanger bar assembly (not shown) may be mounted to the sidewall 1102 of the housing 1100e for installation onto a building structure (e.g., a T-bar, a joist, a stud). A method of installing the recessed lighting system 1000e depicted in FIG. 16 may be substantially similar to the method described above for the recessed lighting system 1000c.

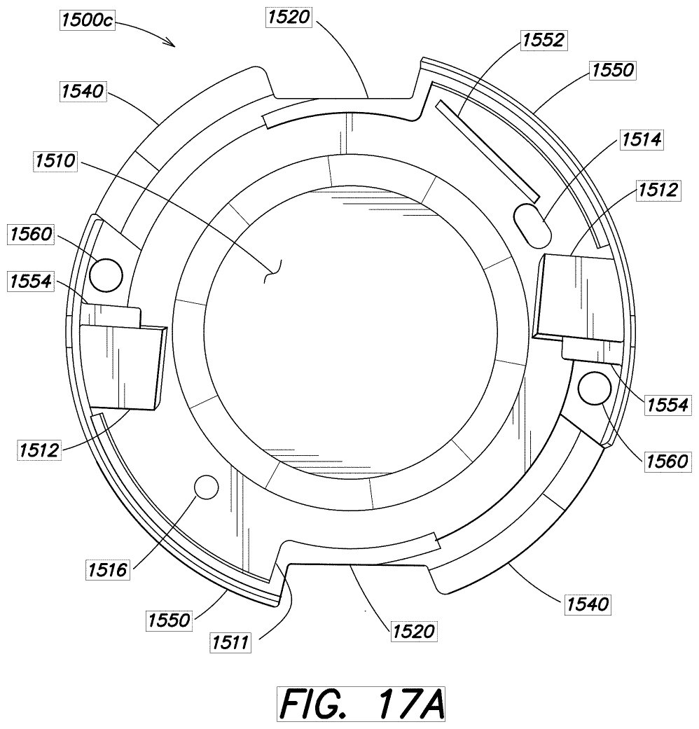

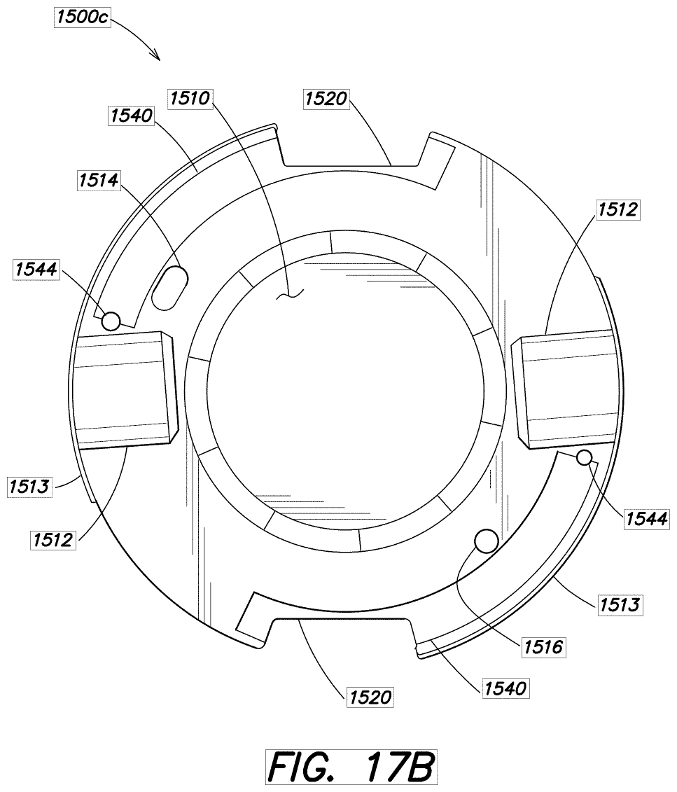

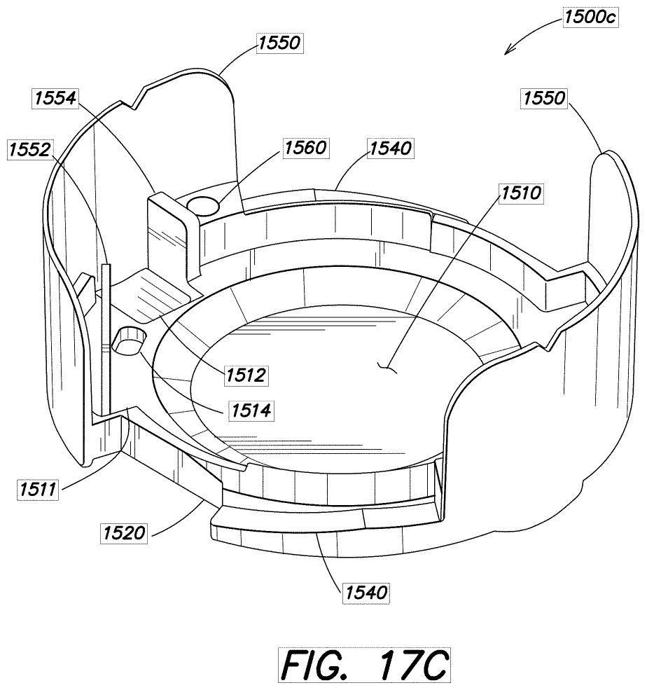

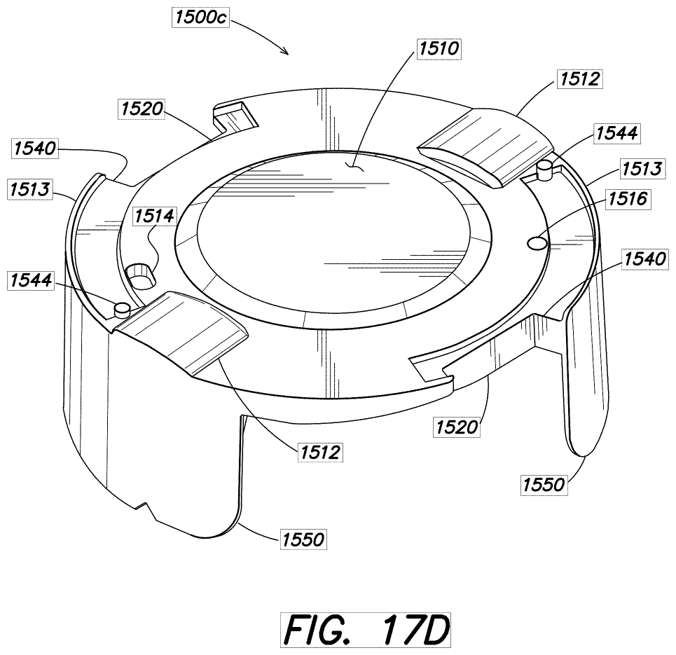

FIGS. 17A-17D show several views of the partition plate 1500c. The partition plate 1500c may include several of the same features described above with respect to the other exemplary recessed lighting fixtures 1000. The partition plate 1500c may additionally include a stand-off connector 1560 disposed on the flange 1511 as shown in FIGS. 17A and 17C. The stand-off connector 1560 may be used to support a stand-off 1562 for assembly of a cover plate 1700 on the housing 1100e. In some implementations, the stand-off connector 1560 may be an opening in the flange 1511 configured to receive an insert. The insert may be threaded to secure the stand-off 1562 to the partition plate 1500c. In some implementations, the insert may be formed from a metal. In some implementations, the opening of the stand-off connector 1560 may be threaded depending on the material used to form the partition plate 1500c. As shown, the partition plate 1500c may include a pair of stand-off connectors 1562 disposed on opposing sides of the flange 1511.

As before, the partition plate 1500c may be formed from various metals, thermoplastic polymers, and thermosetting polymers including, but not limited to aluminum, steel, stainless steel, polyvinyl chloride (PVC), acrylonitrile butadiene styrene (ABS), polycarbonate (PC), and polyurethane (PU), polyethylene, polyethylene terephthalate, polypropylene, polystyrene, a Makrolon® polycarbonate, and a Therma-Tech™ thermally conductive compound. The partition plate 1500c may be fabricated using various manufacturing methods including, but not limited to injection molding, 3D printing, blow molding, casting, and machining.

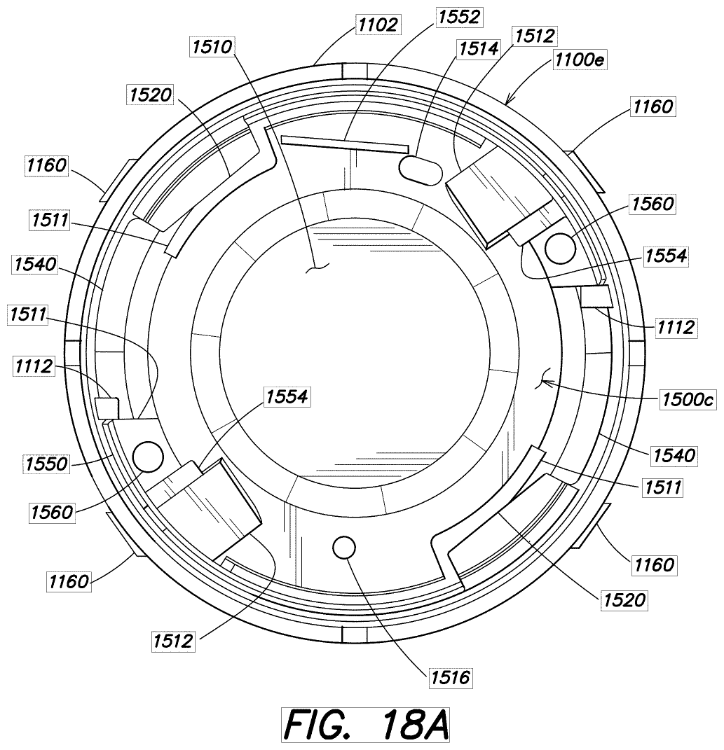

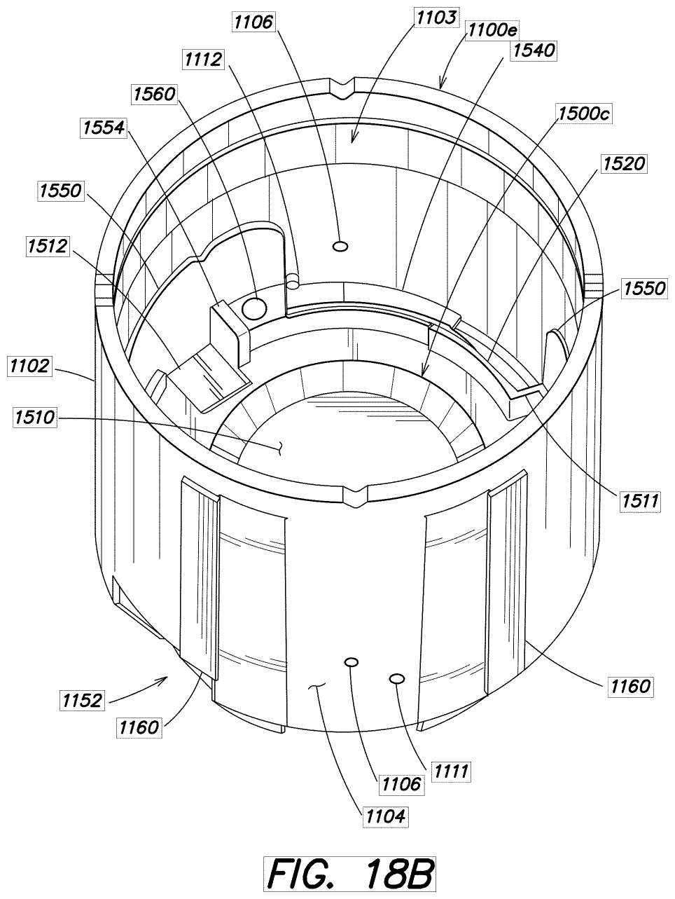

FIGS. 18A and 18B show the partition plate 1500c disposed in the cavity 1101 of the housing 1100e. As shown, the partition plate 1500c may be secured by the peg 1112 on the housing 1100e. Additionally, the stand-off connectors 1562 may be oriented to be accessible by a user after the partition plate 1500c is installed.

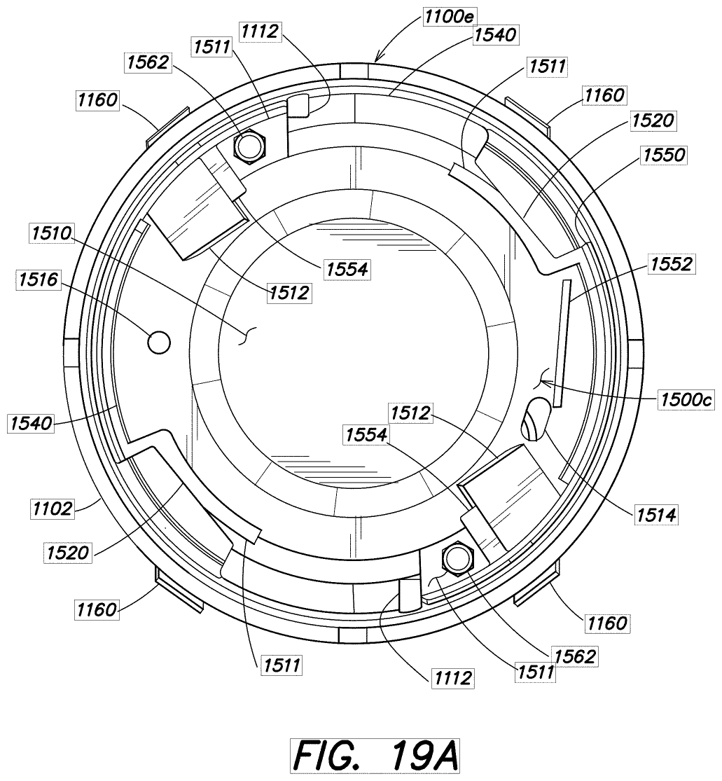

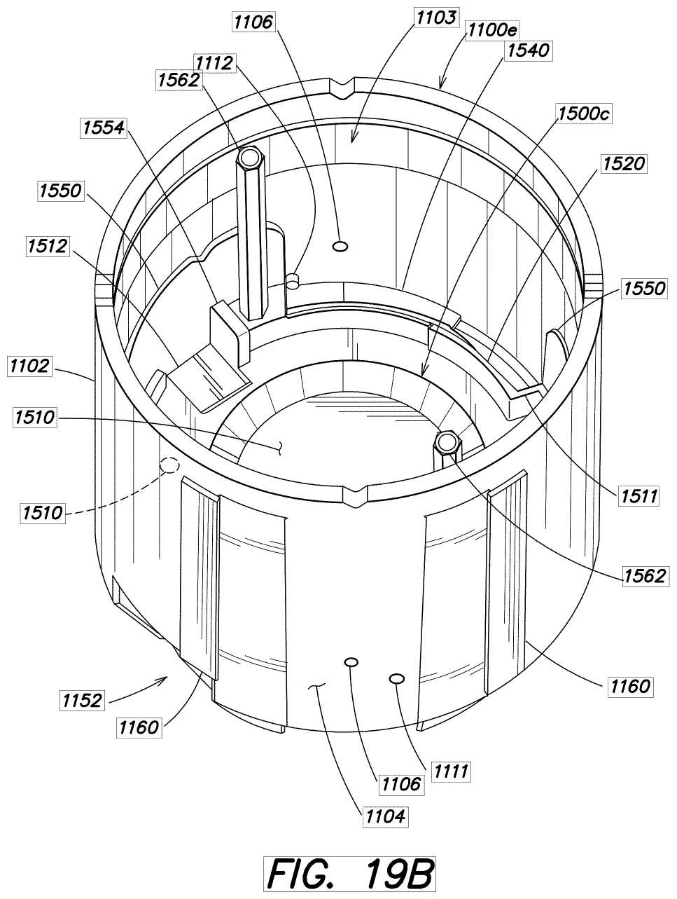

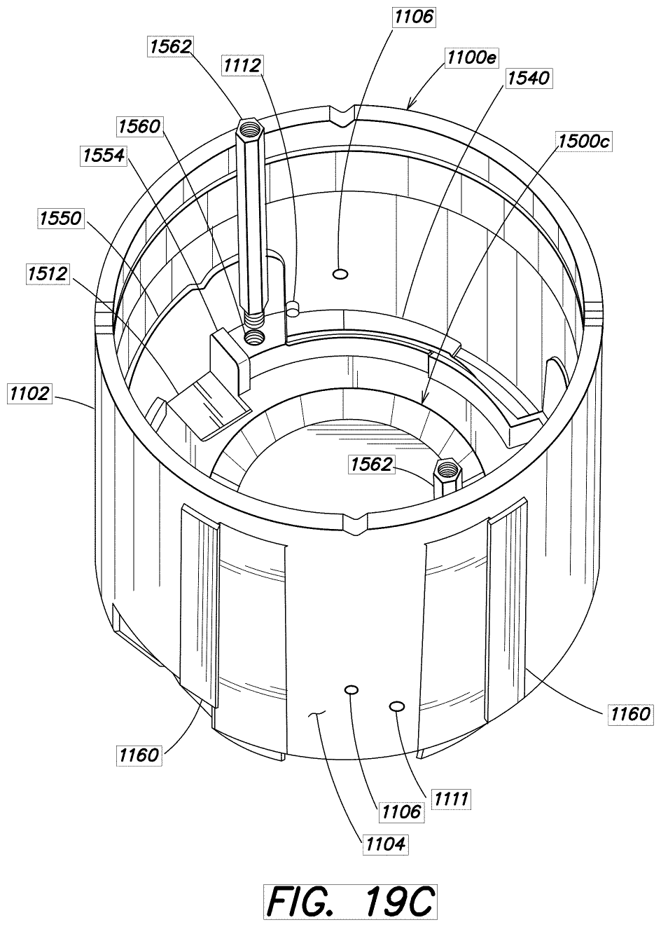

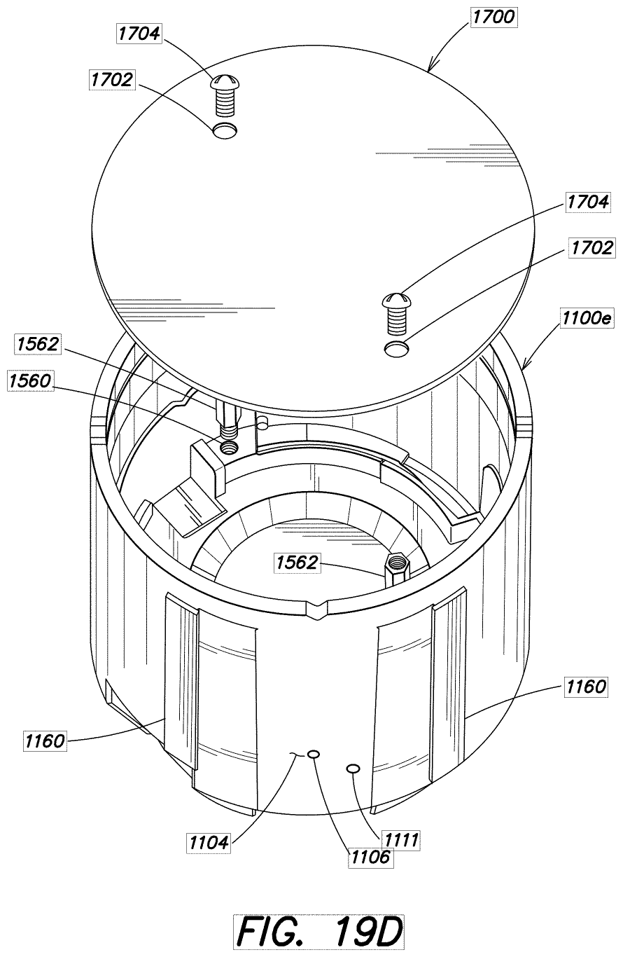

FIGS. 19A-19D show the partition plate 1500c with a stand-off 1562 and a cover plate 1700 disposed on the opening 1103 of the housing 1100e. The cover plate 1700 may be used in a similar manner to where an electrical outlet in a building may be covered when unused such that the wall or ceiling does not have an exposed opening. As shown in FIGS. 19A-19C, the stand-off 1562 may be an elongated component with a coupling mechanism (e.g., a threaded male connector) at one end to connect to the stand-off connector 1560 on the partition plate 1500c. At the other end, the stand-off 1562 may have a coupling mechanism configured to couple the cover plate 1700 to the opening 1103 of the housing 1100e. Various types of coupling mechanisms may be used including, but not limited to a screw fastener, a bolt fastener, a snap fit connector, and an adhesive.

FIG. 19D shows the cover plate 1700 may be placed onto the opening 1103 of the housing 1100e. As shown, the cover plate 1700 may substantially cover the opening 1103. The cover plate 1700 may have various shapes including, but not limited to a circle, an ellipse, a regular polygon, and an irregular polygon. In some implementations, the cover plate 1700 may also include a beveled or a tapered edge where a central portion of the cover plate 1700 protrudes outwards from the opening 1103 of the housing 1100e while an edge portion of the cover plate 1700 abuts a portion of the opening 1103 and/or the ceiling or wall. The cover plate 1700 depicted in FIG. 19D may be coupled to the stand-offs 1562 using screw fasteners 1704 inserted through holes 1702 on the cover plate 1700.

The stand-off 1562 and the cover plate 1700 may be formed from various metals, thermoplastic polymers, and thermosetting polymers including, but not limited to aluminum, steel, stainless steel, polyvinyl chloride (PVC), acrylonitrile butadiene styrene (ABS), polycarbonate (PC), and polyurethane (PU), polyethylene, polyethylene terephthalate, polypropylene, polystyrene, a Makrolon® polycarbonate, and a Therma-Tech™ thermally conductive compound. The stand-off 1562 and the cover plate 1700 may be fabricated using various manufacturing methods including, but not limited to injection molding, 3D printing, blow molding, casting, and machining.

### Conclusion

All parameters, dimensions, materials, and configurations described herein are meant to be exemplary and the actual parameters, dimensions, materials, and/or configurations will depend upon the specific application or applications for which the inventive teachings is/are used. It is to be understood that the foregoing embodiments are presented primarily by way of example and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein.

In addition, any combination of two or more such features, systems, articles, materials, kits, and/or methods, if such features, systems, articles, materials, kits, and/or methods are not mutually inconsistent, is included within the inventive scope of the present disclosure. Other substitutions, modifications, changes, and omissions may be made in the design, operating conditions and arrangement of respective elements of the exemplary implementations without departing from the scope of the present disclosure. The use of a numerical range does not preclude equivalents that fall outside the range that fulfill the same function, in the same way, to produce the same result.

Also, various inventive concepts may be embodied as one or more methods, of which at least one example has been provided. The acts performed as part of the method may in some instances be ordered in different ways. Accordingly, in some inventive implementations, respective acts of a given method may be performed in an order different than specifically illustrated, which may include performing some acts simultaneously (even if such acts are shown as sequential acts in illustrative embodiments).

All publications, patent applications, patents, and other references mentioned herein are incorporated by reference in their entirety.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of” “Consisting essentially of” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1.-45. (canceled)

46. A housing for a lighting system, the housing comprising:
a sidewall defining a cavity and having a first end and a second end disposed opposite to the first end, the first end defining an opening to access the cavity, at least a portion of the sidewall having a circular cross-sectional shape;
a cover having a circular shape to enclose the second end and form a beveled portion;
at least one knockout formed only on the cover; and
at least one feedthrough tab formed on the beveled portion,
wherein the sidewall, the cover, the at least one knockout, and the at least one feedthrough tab are formed as a single component.

47. The housing of claim 46, wherein the housing is formed of at least one of polyvinyl chloride (PVC), polycarbonate (PC), polyurethane (PU), or acrylonitrile butadiene styrene (ABS).

48. The housing of claim 46, wherein the sidewall does not include a fastener opening disposed proximate to or on the first end to receive a fastener.

49. The housing of claim 46, wherein the sidewall has a first exterior diameter proximate to the first end and a second exterior diameter, proximate to the cover, smaller than the first exterior diameter.

50. The housing of claim 46, wherein the sidewall further comprises:
four notches formed on the first end of the sidewall to divide the first end of the sidewall into four curved segments of equal length.

51. The housing of claim 46, wherein:
the at least one feedthrough tab forms a feedthrough opening for an electrical cable to enter the cavity when the at least one feedthrough tab is bent into the cavity; and
the at least one feedthrough tab generates a restraining force to hold the electrical cable in place within the cavity when the at least one feedthrough tab is bent and the electrical cable is present.

52. The housing of claim 51, further comprising:
the electrical cable fed through the feedthrough opening by bending the at least one feedthrough tab into the cavity, the electrical cable being a non-metallic sheathed cable.

53. The housing of claim 46, wherein:
the cover has a first thickness; and
the at least one knockout has a second thickness smaller than the first thickness.

54. The housing of claim 53, wherein:
the cover has a first surface abutting the cavity and a second surface opposite the first surface; and
the at least one knockout does not protrude from the first and second surfaces of the cover.

55. The housing of claim 46, wherein the cavity is sufficiently large to contain at least 8 electrical cables where each electrical cable has a gauge greater than or equal to 12, a light module, and at least a portion of a trim when the electrical cables, the light module, and the trim are present.

56. The housing of claim 46, wherein the cavity has a volume that ranges between 15 cubic inches and 30 cubic inches.

57. A housing for a lighting system, comprising:
a sidewall defining a cavity and having a first end and a second end disposed opposite the first end, the first end defining an opening to access the cavity;
a cover to enclose the second end and form a beveled portion;
at least one knockout formed only on the cover; and
at least one feedthrough tab formed on the beveled portion,
wherein:
the sidewall, the cover, the at least one knockout, and the at least one feedthrough tab are formed of a polymer; and
the sidewall does not include a hole disposed proximate to or on the first end to receive a fastener.

58. The housing of claim 57, wherein the polymer includes at least one of polyvinyl chloride (PVC), polycarbonate (PC), polyurethane (PU), or acrylonitrile butadiene styrene (ABS).

59. The housing of claim 57, wherein the sidewall has a first exterior diameter proximate to the first end and a second exterior diameter, proximate to the cover, that is smaller than the first exterior diameter.

60. The housing of claim 57, wherein the sidewall has a circular cross-sectional shape.

61. The housing of claim 57, wherein:
the at least one feedthrough tab forms a feedthrough opening for an electrical cable to enter the cavity when the at least one feedthrough tab is bent into the cavity; and
the at least one feedthrough tab generates a restraining force to hold the electrical cable in place within the cavity when the at least one feedthrough tab is bent and the electrical cable is present.

62. The housing of claim 57, wherein:
the at least one feedthrough tab comprises:
a first feedthrough tab; and
a second feedthrough tab disposed diametrically opposite to the first feedthrough tab; and
at least a portion of the at least one knockout is disposed between the first and second feedthrough tabs.

63. A lighting system, comprising:
the housing of claim 57;
a light module, disposed in the cavity of the housing, to emit light out of the opening of the housing;
a trim, partially disposed in the cavity of the housing such that only a flange of the trim is disposed outside the cavity; and
an electrical cable, routed into the cavity of the housing through a feedthrough opening formed by bending the at least one feedthrough tab into the cavity, to supply power to the light module.

64. A housing for a lighting system, comprising:
a sidewall defining a cavity and having a first end and a second end disposed opposite to the first end, the first end defining an opening to access the cavity, at least a portion of the sidewall having a circular cross-sectional shape, the sidewall having four notches formed on the first end to divide the first end into four curved segments of equal length;
a cover to enclose the second end and form a beveled portion, the cover having a circular shape and a first thickness;
a first feedthrough tab formed on the beveled portion;
a second feedthrough tab formed on the beveled portion and disposed diametrically opposite to the first feedthrough tab; and
at least one knockout formed only on the cover and disposed between the first and second feedthrough tabs, the at least one knockout having a second thickness smaller than the first thickness,
wherein:
the sidewall, the cover, the first feedthrough tab, the second feedthrough tab, and the at least one knockout are formed as a single component from at least one of polyvinyl chloride (PVC) or polycarbonate (PC);
the sidewall does not include a fastener opening disposed proximate to or on the first end to receive a fastener; and
the sidewall has a first exterior diameter proximate to the first end and a second exterior diameter proximate to the cover that is smaller than the first exterior diameter.

65. A lighting system, comprising:
the housing of claim 64;
a light module, disposed in the cavity of the housing, to emit light out of the opening of the housing;
a trim, partially disposed in the cavity of the housing such that only a flange of the trim is disposed outside the cavity; and
a plurality of electrical cables, routed into the cavity of the housing through one or more feedthrough openings formed by at least one of removing the at least one knockout or bending the first feedthrough tab and/or the second feedthrough tab, to at least one of supply power to the light module or transmit power.
